(19) United States
(12) Patent Application Publication
(10) Pub. No.: US 2016/0342545 A1
(43) Pub. Date: Nov. 24, 2016

(54) DATA MEMORY DEVICE

(71) Applicant: HITACHI, LTD., Tokyo (JP)

(72) Inventors: Masahiro ARAI, Tokyo (JP); Akifumi SUZUKI, Tokyo (JP); Mitsuhiro OKADA, Tokyo (JP); Yuji ITO, Tokyo (JP); Kazuei HIRONAKA, Tokyo (JP); Satoshi MORISHITA, Tokyo (JP); Norio SHIMOZONO, Tokyo (JP)

(73) Assignee: HITACHI, Ltd., Tokyo (JP)

(21) Appl. No.: 15/114,573

(22) PCT Filed: Feb. 12, 2014
(86) PCT No.: PCT/JP2014/053107

§ 371 Date: Jul. 27, 2016

(51) Int. Cl. G06F 13/28; G06F 11/07; G06F 13/16; G06F 13/42; G06F 3/06; G06F 12/0868

(52) U.S. Cl. CPC G06F 13/28; G06F 3/061; G06F 3/0656; G06F 3/0659; G06F 3/0638; G06F 3/0689; G06F 3/0683; G06F 12/0868; G06F 13/1673; G06F 13/4282; G06F 11/0727; G06F 11/0751; G06F 11/0772; G06F 2212/1016; G06F 2213/0026

(57) ABSTRACT

A data memory device has a command transfer direct memory access (DMA) engine configured to obtain a command that is generated by an external apparatus to give a data transfer instruction from a memory of the external apparatus; obtain specifics of the instruction; store the command in a command buffer; obtain a command number that identifies the command being processed; and activate a transfer list generating DMA engine by transmitting the command number depending on the specifics of the instruction of the command. The transfer list generating DMA engine is configured to: identify, based on the command stored in the command buffer, an address in the memory to be transferred between the external apparatus and the data memory device; and activate the data transfer DMA engine by transmitting the address to the data transfer DMA engine which then transfers the data to/from the memory based on the received address.

### BACKGROUND OF THE INVENTION

This invention relates to a PCIe connection-type data memory device.

Computers and storage systems in recent years require a memory area of large capacity for fast analysis and fast I/O processing of a large amount of data. An example thereof in computers is in-memory DBs and other similar types of application software. However, the capacity of a DRAM that can be installed in an apparatus is limited for cost reasons and electrical mounting constraints. As an interim solution, NAND flash memories and other semiconductor storage media that are slower than DRAMs but faster than HDDs are beginning to be used in some instances.

Semiconductor storage media of this type are called solid state disks (SSDs) and, as “disk” in the name indicates, have been used by being coupled to a computer or a storage controller via disc I/O interface connection by a serial ATA (SATA) or a serial attached SCSI (SAS) and via a protocol therefore.

Access via the disk I/O interface and protocol, however, is high in overhead and in latency, and is detrimental to the improvement of computer performance. PCIe connection-type SSDs (PCIe-SSDs or PCIe-Flashes) are therefore emerging in more recent years. PCIe-SSDs can be installed on a PCI-Express (PCIe) bus, which is a general-purpose bus that can be coupled directly to a processor, and can be accessed at low latency with the use of the NVMe protocol, which has newly been laid down in order to make use of the high speed of the PCIe bus.

In NVMe, I/O commands supported for data transmission/reception are very simple, and only three commands need to be supported, namely, “write”, “read”, and “flush”.

While a host takes the active role in transmitting a command or data to the device side in older disk I/O protocols, e.g., SAS, a host in NVMe only notifies the fact that a command has been created to the device, and it is the device side that takes the lead in fetching the command in question and transferring data. In short, the host's action is replaced by an action on the device side. For example, a command “write” addressed to the device is carried out in NVMe by the device's action of reading data on the host, whereas the host transmits write data to the device in older disk I/O protocols. On the other hand, when the specifics of the command are “read”, the processing of the read command is carried out by the device's action of writing data to a memory on the host.

In other words, in NVMe, where a trigger for action is pulled by the device side for command reception and data read/write transfer both, the device does not need to secure extra resources in order to be ready to receive a request from the host any time.

In older disk I/O protocols, the host and the device add an ID or a tag that is prescribed in the protocol to data or a command exchanged between the host and the device, instead of directly adding an address. At the time of reception, the host or the device that is the recipient converts the ID or the tag into a memory address of its own (part of protocol conversion), which means that protocol conversion is necessary whichever of a command and data is received, and makes the overhead high. In NVMe, in contrast, the storage device executes data transfer by reading/writing data directly in a memory address space of the host. This makes the overhead and latency of protocol conversion low.

NVMe is thus a light-weight communication protocol in which the command system is simplified and the transfer overhead (latency) is reduced. A PCIe SSD (PCIe-Flash) device that employs this protocol is accordingly demanded to have high I/O performance and fast response performance (low latency) that conform to the standards of the PCI-Express band.

In U.S. Pat. No. 8,370,544 B2, there is disclosed a system in which a processor of an SSD coupled to a host computer analyzes a command received from the host computer and, based on the specifics of the analyzed command, instructs a direct memory access (DMA) engine inside a host interface to transfer data. In the SSD of U.S. Pat. No. 8,370,544 B2, data is compressed to be stored in a flash memory, and the host interface and a data compression engine are arranged in series.

### SUMMARY OF THE INVENTION

Using the technology of U.S. Pat. No. 8,370,544 B2 to enhance performance, however, has the following problems.

Firstly, the processing performance of the processor presents a bottleneck. Improving performance under the circumstances described above requires improvement in the number of I/O commands that can be processed per unit time. In U.S. Pat. No. 8,370,544 B2, all determinations about operation and the activation of DMA engines are processed by the processor, and improving I/O processing performance therefore requires raising the efficiency of the processing itself or enhancing the processor. However, increasing the physical quantities of the processor, such as frequency and the number of cores, increases power consumption and the amount of heat generated as well. In cache devices and other devices that are used incorporated in a system for use, there are generally limitations to the amount of heat generated and power consumption from space constraints and for reasons related to power feeding, and the processor therefore cannot be enhanced unconditionally. In addition, flash memories are not resistant to heat, which makes it undesirable to mount parts that generate much heat in a limited space.

Secondly, with the host interface and the compression engine arranged in series, two types of DMA transfer are needed to transfer data, and the latency is accordingly high, thus making it difficult to raise response performance. The transfer is executed by activating the DMA engine of the host interface and a DMA engine of the compression engine, which means that two sessions of DMA transfer are inevitable part of any data transfer, and that the latency is high.

This is due to the fact that U.S. Pat. No. 8,370,544 B2 is configured so as to be compatible with Fibre Channel, SAS, and other transfer protocols that do not allow the host and the device to access memories of each other directly.

This invention has been made in view of the problems described above, and an object of this invention is therefore to accomplish data transfer that enables fast I/O processing at low latency by using a DMA engine, which is a piece of hardware, instead of enhancing a processor, in a memory device using NVMe or a similar protocol in which data is exchanged with a host through memory read/write requests.

The present invention can be appreciated by the description which follows in conjunction with the following figures, wherein: A data memory device, comprising: a storage medium configured to store data, a command buffer configured to store a command that is generated by an external apparatus to give a data transfer instruction, a command transfer direct memory access (DMA) engine, which is coupled to the external apparatus and which is a hardware circuit, a transfer list generating DMA engine, which is coupled to the external apparatus and which is a hardware circuit, and a data transfer DMA engine, which is coupled to the external apparatus and which is a hardware circuit.

The command transfer DMA engine is configured to obtain the command from a memory of the external apparatus, obtain specifics of the instruction of the command, store the command in the command buffer, obtain a command number that identifies the command being processed, and activate the transfer list generating DMA engine by transmitting the command number depending on the specifics of the instruction of the command. The transfer list generating DMA engine is configured to identify, based on the command stored in the command buffer, an address in the memory to be transferred between the external apparatus and the data memory device, and activate the data transfer DMA engine by transmitting the address to the data transfer DMA engine. The data transfer DMA engine is configured to transfer data to/from the memory based on the received address.

According to this invention, a DMA engine provided for each processing phase in which access to a host memory takes place can execute transfer in parallel to transfer that is executed by other DMA engines and without involving other DMA engines on the way, thereby accomplishing data transfer at low latency. This invention also enables the hardware to operate efficiently without waiting for instructions from a processor, and eliminates the need for the processor to issue transfer instructions to DMA engines and to confirm the completion of transfer as well, thus reducing the number of processing commands of the processor. The number of I/O commands that can be processed per unit time is therefore improved without enhancing the processor. With the processing efficiency improved for the processor and for the hardware both, the overall I/O processing performance of the device is improved.

### BRIEF DESCRIPTION OF THE DRAWINGS

The present invention can be appreciated by the description which follows in conjunction with the following figures, wherein:

FIG. 1 is a block diagram of a PCIe connection-type cache memory device in a first embodiment of this invention;

FIG. 2A is an exterior view of the PCIe connection-type cache memory device in the first embodiment;

FIG. 2B is an exterior view of the PCIe connection-type cache memory device in the first embodiment;

FIG. 3 is a schematic diagram for illustrating processing steps of I/O between the PCIe connection-type cache memory device and a host apparatus in the first embodiment;

FIG. 4 is a block diagram for illustrating the configuration of an NVMe DMA engine in the first embodiment;

FIG. 5 is a diagram for illustrating the configuration of an PARAM DMA engine in this embodiment;

FIG. 6 is a diagram for illustrating the configuration of an DATA DMA engine in this embodiment;

FIG. 7 is a diagram for illustrating the configuration of management information, which is put on an SRAM in the first embodiment;

FIG. 8 is a diagram for illustrating the configuration of buffers, which are put on a DRAM in the first embodiment;

FIG. 9 is a flow chart of the processing operation of hardware in the first embodiment;

FIG. 10 is a schematic diagram for illustrating I/O processing that is executed by cooperation among DMA engines in the first embodiment;

FIG. 11 is a block diagram for illustrating the configuration of an RMW DMA engine in the first embodiment;

FIG. 12 is a flow chart of read modify write processing in write processing for writing from the host in the first embodiment;

FIG. 13 is a block diagram of a storage system in which a cache memory device in a second embodiment of this invention is installed;

FIG. 14 is a flow chart of write processing of the storage system in the second embodiment;

FIG. 15 is a flow chart of read processing of the storage system in the second embodiment;

FIG. 16 is a schematic diagram of address mapping inside the cache memory device in the second embodiment;

FIG. 17 is a block diagram of another cache memory device in the first embodiment;

FIG. 18 is a block diagram of still another cache memory device in the first embodiment; and

FIG. 19 is a diagram for illustrating an NVMe command format in the first embodiment.

### DETAILED DESCRIPTION OF THE PREFERRED EMBODIMENTS

Modes for carrying out this invention are described through a first embodiment and a second embodiment of this invention. Modes that can be carried out by partially changing the first embodiment or the second embodiment are described as modification examples in the embodiment in question.

### First Embodiment

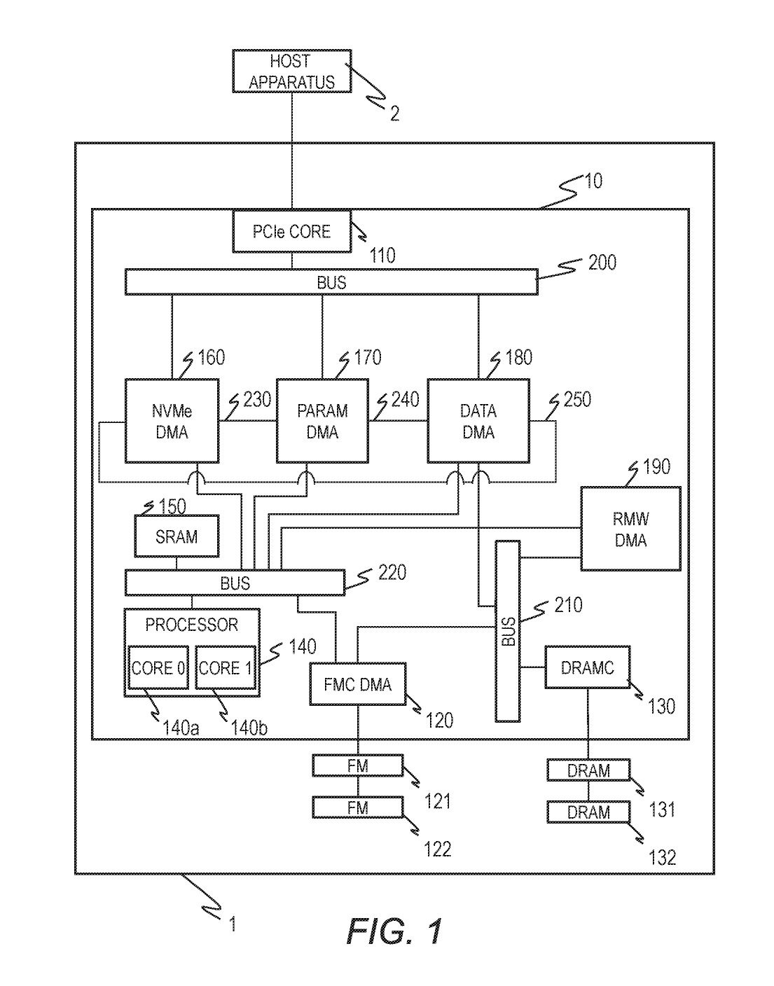

This embodiment is described with reference to FIG. 1 to FIG. 12 and FIG. 19.

FIG. 1 is a block diagram for illustrating the configuration of a cache device in this embodiment. A cache device 1 is used while being coupled to a host apparatus 2 via a PCI-Express (PCIe) bus. The host apparatus 2 uses command sets of the NVMe protocol to input/output generated data and data received from other apparatus and devices. Examples of the host apparatus 2 include a server system and a storage system (disk array) controller. The host apparatus 2 can also be phrased as an apparatus external to the cache device.

The cache device 1 includes hardware logic 10, which is mounted as an LSI or an FGPA, flash memory chips (FMs) 121 and 122, which are used as storage media of the cache device 1, and dynamic random access memories (DRAMs) 131 and 132, which are used as temporary storage areas. The FMs 121 and 122 and the DRAMs 131 and 132 may be replaced by other combinations as long as different memories in terms of price, capacity, performance, or the like are installed for different uses. For example, a combination of resistance random access memories (ReRAMs) and magnetic random access memories (MRAMs), or a combination of phase change memories (PRAMs) and DRAMs may be used. A combination of single-level cell (SLC) NANDs and triple-level cell (TLC) NANDs may be used instead. The description here includes two memories of each of the two memory types as an implication that a plurality of memories of the same type can be installed, and the cache device 1 can include one or a plurality of memories of each memory type. The capacity of a single memory does not need to be the same for one memory type and the other memory type, and the number of mounted memories of one memory type does not need to be the same as the number of mounted memories of the other memory type.

The hardware logic 10 includes a PCIe core 110 through which connection to/from the host apparatus 2 is made, an FM controller DMA (FMC DMA) engine 120, which is a controller configured to control the FMs 121 and 122 and others and which is a DMA engine, and a DRAM controller (DRAMC) 130 configured to control the DRAMs 131 and 132 and others. The hardware logic 10 further includes a processor 140 configured to control the interior of the hardware logic 10, an SRAM 150 used to store various types of information, and DMA engines 160, 170, 180, and 190 for various types of transfer processing. While one FMC DMA engine 120 and one DRAMC 130 are illustrated in FIG. 1, a plurality of FMC DMA engines 120 and a plurality of DRAMCs 130 may be provided depending on the capacity or the level of performance to be supported. A plurality of channels or buses may be provided under one FMC DMA engine 120 or one DRAMC 130. Conversely, a plurality of FMC DMA engines 120 may be provided for one channel or one bus.

The PCIe core 110 described above is a part that has minimum logic necessary for communication in the physical layer of PCIe and layers above the physical layer, and plays the role of bridging access to a host apparatus-side memory space. A bus 200 is a connection mediating unit configured to mediate access of the various DMA engines 160, 170, and 180 to the host apparatus-side memory space through the PCIe core 110.

A bus 210 is similarly a connection unit that enables the various DMA engines 180 and 190 and the FMC DMA engine 120 to access the DRAMs 131 and 132. A bus 220 couples the processor 140, the SRAM 150, and the various DMA engines to one another. The buses 200, 210, and 220 can be in the mode of a switch coupling network without changing their essence.

The various DMA engines 160, 170, and 180 described above are each provided for a different processing phase in which access to a memory of the host apparatus 2 takes place in NVMe processing. Specifically, the DMA engine 160 is an NVMe DMA engine 160 configured to receive an NVMe command and execute response processing (completion processing), the DMA engine 170 is a PARAM DMA engine 170 configured to obtain a PRP list which is a list of transfer source addresses or transfer destination addresses, and the DMA engine 180 is a DATA DMA engine 180 configured to transfer user data while compressing/decompressing the data as needed. The DMA engine 190 is an RMW DMA engine 190 configured to merge (read-modify) compressed data and non-compressed data on the FMs 121 and 122 or on the DRAMs 131 and 132. Detailed behaviors of the respective DMA engines are described later.

Of those DMA engines, the DMA engines 160, 170, and 180, which need to access the memory space of the host apparatus 2, are coupled in parallel to one another via the bus 200 to the PCIe core 110 through which connection to the host apparatus 2 is made so that the DMA engines 160, 170, and 180 can access the host apparatus 2 independently of one another and without involving extra DMA engines on the way. Similarly, the DMA engines 120, 180, and 190, which need to access the DRAMs 131 and 132, are coupled in parallel to one another via the bus 210 to the DRAMC 130. The NVMe DAM engine 160 and the PARAM DMA engine 170 are coupled to each other by a control signal line 230. The PARAM DMA engine 170 and the DATA DMA engine 180 are coupled to each other by a control signal line 240. The DATA DMA engine 180 and the NVMe DMA engine 160 are coupled to each other by a control signal line 250.

In this manner, three different DMA engines are provided for different processing phases in this embodiment. Because different processing requires a different hardware circuit to build a DMA engine, a DMA engine provided for specific processing can execute the processing faster than a single DMA engine that is used for a plurality of processing phases. In addition, while one of the DMA engines is executing processing, the other DMA engines can execute processing in parallel, thereby accomplishing even faster command processing. The bottleneck of the processor is also solved in this embodiment, where data is transferred without the processor issuing instructions to the DMA engines. The elimination of the need to wait for instructions from the processor also enables the DMA engines to operate efficiently. For the efficient operation, the three DMA engines need to execute processing in cooperation with one another. Cooperation among the DMA engines is described later.

If the DMA engines are coupled in series, the PARAM DMA engine 170, for example, needs to access the host apparatus 2 via the NVMe DMA engine 160 in order to execute processing, and the DATA DMA engine 180 needs to access the host apparatus 2 via the NVMe DMA engine 160 and the PARAM DMA engine 170 in order to execute processing. This makes the latency high and invites a drop in performance. In this embodiment, where three DMA engines are provided in parallel to one another, each DMA engine has no need to involve other DMA engines to access the host apparatus 2, thereby accomplishing further performance enhancement.

This embodiment is thus capable of high performance data transfer that makes use of the broad band of PCIe by configuring the front end-side processing of the cache device as hardware processing.

High I/O performance and high response performance mean an increased amount of write to an mounted flash memory per unit time. Because flash memory is a medium that has a limited number of rewrite cycles, even if performance is increased, measures to inhibit an increase of the rewrite count (or erasure count) need to be taken. The cache device of this embodiment includes a data compressing hardware circuit for that reason. This reduces the amount of data write, thereby prolonging the life span of the flash memory. Compressing data also increases the amount of data that can be stored in the cache device substantially and an improvement in cache hit ratio is therefore expected, which improves the system performance.

The processor 140 is an embedded processor, which is provided inside an LSI or an FPGA, and may have a plurality of cores such as cores 140a and 140b. Control software of the device 1 runs on the processor 140 and performs, for example, the control of wear leveling and garbage collection of an FM, the management of logical address-physical address mapping of a flash memory, and the management of the life span of each FM chip. The processor 140 is coupled to the bus 220. The SRAM 150 coupled to the bus 220 is used to store various types of information that need to be accessed quickly by the processor and by the DMA engines, and is used as a work area of the control software. The various types of DMA engines are coupled to the bus 220 as well in order to access the SDRAM 150 and to hold communication to and from the processor.

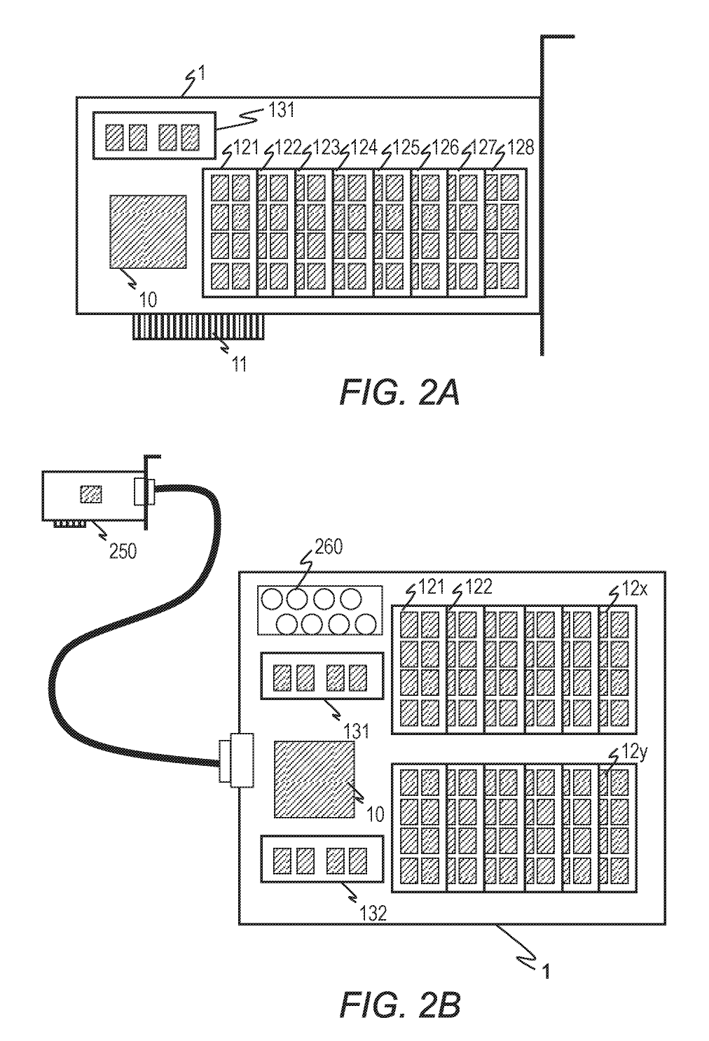

FIG. 2A and FIG. 2B are exterior images of the cache device 1 described with reference to FIG. 1, and are provided for deeper understanding of the cache device 1. FIG. 2A is described first.

FIG. 2A is an image of the cache device 1 that is mounted in the form of a PCIe card. In FIG. 2A, the whole exterior is of the cache device 1, and the hardware logic 10 is mounted as an LSI (a mode in which the hardware logic 10 is an FPGA and a mode in which the hardware logic 10 is an ASIC are included) on the left hand side of FIG. 2A. In addition to this, the DRAM 131 and flash memories (FMs) 121 to 127 are mounted in the card in the form of a DIMM, and are, coupled to the host apparatus through a card edge 11. Specifically, the PCIe core 110 is mounted in the LSI, and a signal line is laid so as to run toward the card edge 11. The edge 11 may have the shape of a connector. Though not shown in FIG. 2A, a battery or a supercapacitor that plays an equivalent role to the battery may be mounted as a protection against the volatilization of the DRAM 131 of the cache device 1.

FIG. 2B is an image of the cache device 1 that is mounted as a huge package board. The board shown on the right hand side of FIG. 2B is the cache device 1 where, as in FIG. 2A, the hardware logic 10, the DRAMs 131 and 132, and many FMs including the FM 121 are mounted. Connection to the host apparatus is made via a cable that extends a PCIe bus to the outside and an adapter such as a PCIe cable adapter 250. The cache device 1 that is in the form of a package board is often housed in a special casing in order to supply power and cool the cache device 1.

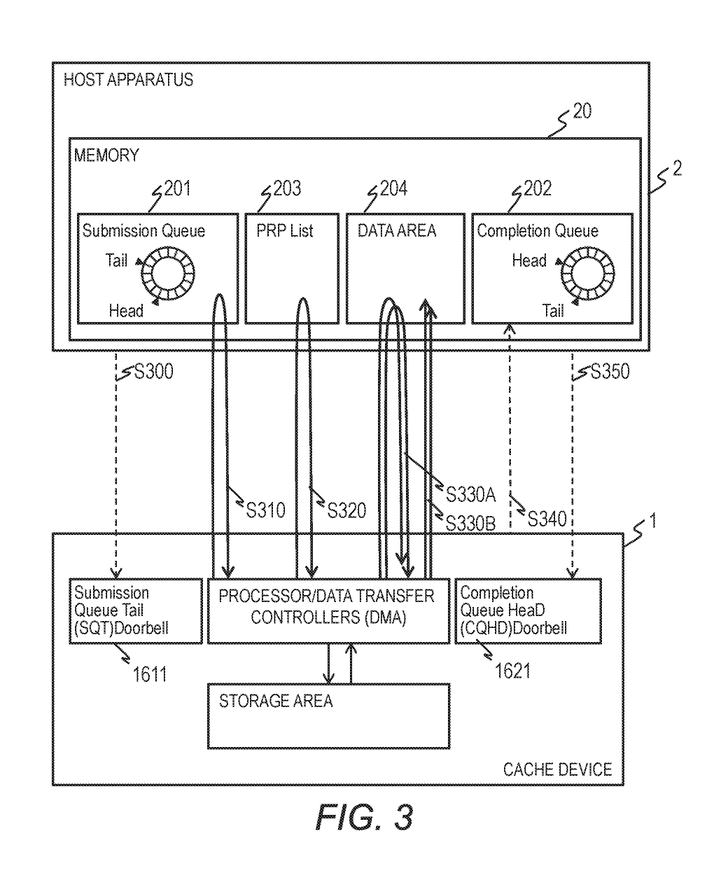

FIG. 3 is a diagram for schematically illustrating the flow of NVMe command processing that is executed between the cache device 1 and the host apparatus 2.

To execute I/O by NVMe, the host apparatus 2 generates a submission command in a prescribed format 1900. In the memory area of the memory 20 of the host apparatus 2, a submission queue 201 for storing submission commands and a completion queue 202 for receiving command completion notifications are provided for each processor core. The queues 201 and 202 are ring buffers configured to queue commands as so named. The enqueue side of the queues 201 and 202 is managed with a tail pointer, the dequeue side of the queues 201 and 202 is managed with a head pointer, and a difference between the two pointers is used to manage whether or not there are queued commands. The head addresses of the respective queue areas are informed to the cache device 1 with the use of an administration command of NVMe at the time of initialization. Each individual area where a command is stored in the queue areas is called an entry.

In addition to those described above, a data area 204 for storing data to be written to the cache device 1 and data read out of the cache device 1, an area 203 for storing a physical region page (PRP) list that is a group of addresses listed when the data area 204 is specified, and other areas are provided in the memory 20 of the host apparatus 2 dynamically as the need arises. A PRP is an address assigned to each memory page size that is determined in NVMe initialization. In a case of a memory page size of 4 KB, for example, data whose size is 64 KB is specified by using sixteen PRPs for every 4 KB. Returning to FIG. 3. The cache device 1 is provided with a submission queue tail (SQT) doorbell 1611 configured to inform that the host apparatus 2 has queued a command in the submission queue 201 and has updated the tail pointer, and a completion queue head (CQHD) doorbell 1621 configured to inform that the host apparatus 2 has taken a “completion” notification transmitted by the cache device 1 out of the completion queue and has updated the head pointer. The doorbells are usually a part of a control register, and are allocated a memory address space that can be accessed by the host apparatus 2.

The terms “tail” and “head” are defined by the concept of FIFO, and a newly created command is added to the tail while previously created commands are processed starting from the head.

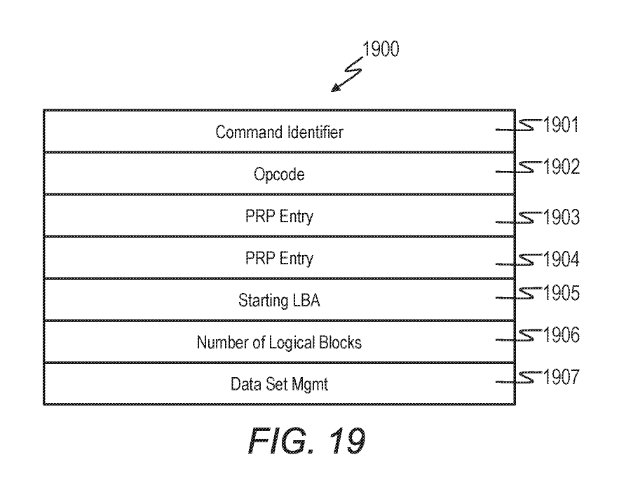

Commands generated by the host apparatus 2 are described. FIG. 19 is a diagram for illustrating a command formant in NVMe. The format 1900 includes the following fields. Specifically, a command identifier field 1901 is an area in which the ID of a command is stored. An opcode field 1902 is an area in which information indicating the specifics of processing that is ordered by the command, e.g., read or write, is stored. PRP entry fields 1903 and 1904 are areas in which physical region pages (PRPs) are stored. NVMe command fields can store two PRPs at maximum. In a case where sixteen PRPs are needed as in the example given above, the fields are not sufficient and an address list is provided in another area as a PRP list. Information indicating the area where the PRP list is stored (an address in the memory 20) is stored in the PRP entry field 1904 in this case. A starting LBA field 1905 is an area in which the start location of an area where data is written or read is stored. A number-of-logical-blocks field 1906 is an area in which the size of the data to be read or written is stored. A data set mgmt field 1907 is an area in which information giving an instruction on whether or not the data to be written needs to be compressed or whether or not the data to be read needs to be decompressed is stored. The format 1990 may other fields than the ones illustrated in FIG. 19.

Returning to FIG. 3, the flow of command processing is described. The host apparatus 2 creates submission commands in order of empty entries of the submission queue 201 in the command format defined by the NVMe standards. The host apparatus 2 writes a final entry number used for the submission queue tail (STQ) doorbell 1611, namely, the value of the tail pointer, in order to notify the cache device 1 that commands have been generated (S300).

The cache device 1 polls the SQT doorbell 1611 at a certain operation cycle to detect whether or not a new command has been issued based on a difference that is obtained by comparing a head pointer managed by the cache device 1 and the SQT doorbell. In a case where a command has newly been issued, the cache device 1 issues a PCIe memory read request to obtain the command from the relevant entry of the submission queue 201 in the memory 20 of the host apparatus 2, and analyzes settings specified in the respective parameter fields of the obtained command (S310).

The cache device 1 executes necessary data transfer processing that is determined from the specifics of the command (S320 and S330).

Prior to the data transfer, the cache device 1 obtains PRPs in order to find out a memory address in the host apparatus 2 that is the data transfer source or the data transfer destination. As described above, the size of PRPs that can be stored in PRP storing fields within the command is limited to two PRPs and, when the transfer length is long, the command fields store an address at which a PRP list is stored, instead of PRPs themselves. The cache device 1 in this case uses this address to obtain the PRP list from the memory 20 of the host apparatus 2 (S320).

The cache device 1 then obtains a series of PRPs from the PRP list, thereby obtaining the transfer source address or the transfer destination address.

In NVMe, the cache device 1 takes the lead in all types of transfer. For example, when a write command is issued, that is, when a doorbell is rung, the cache device 1 first accesses the memory 20 with the use of a PCIe memory read request in order to obtain the specifics of the command. The cache device 1 next accesses the memory 20 again to obtain PRPs. The cache device 1 then accesses the memory 20 for the last time to read user data, and stores the user data in its own storage area (e.g., one of the DRAMs) (S330A).

Similarly, when a doorbell is rung for a read command, the cache device 1 first accesses the memory 20 with the use of a PCIe memory read request to obtain the specifics of the command, next accesses the memory 20 to obtain PRPs, and lastly writes user data at a memory address in the host apparatus 2 that is specified by the PRPs, with the use of a PCIe memory write request (S330B).

It is understood from the above that, for any command, the flow of command processing from the issuing of the command to data transfer is made up of three phases of processing of accessing the host apparatus 2: (1) command obtaining (S310), (2) the obtaining of a PRP list (S320), and (3) data transfer (S330A or S330B).

After the data transfer processing is finished, the cache device 1 writes a “complete” status in the completion queue 202 of the memory 20 (S340). The cache device 1 then notifies the host apparatus 2 of the update to the completion queue 202 by MSI-X interrupt of PCIe in a manner determined by the initial settings of PCIe and NVMe.

The host apparatus 2 confirms the completion by reading this “complete” status out of the completion queue 202. Thereafter, the host apparatus 2 advances the head pointer by an amount that corresponds to the number of completion notifications processed. Through write to the CQHD doorbell 1621, the host apparatus 2 informs the cache device 1 that the command completion notification has been received from the cache device 1 (S350).

In a case where the “complete” status indicates an error, the host apparatus 2 executes failure processing that suits the specifics of the error. Through the communications described above, the host apparatus 2 and the cache device 1 process one NVMe I/O command.

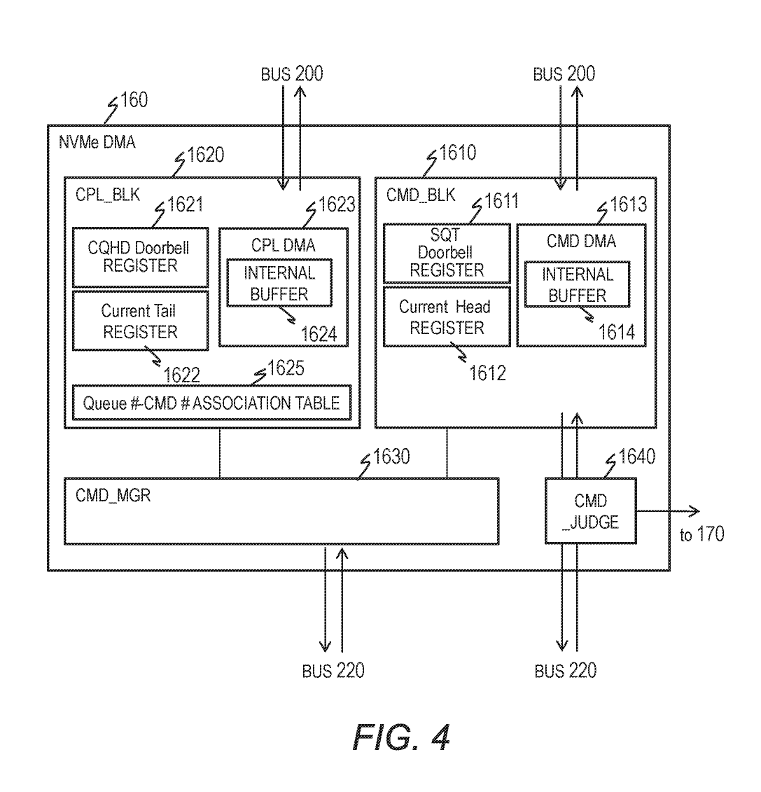

The following description is given with reference to FIG. 4 to FIG. 8 about details of the DMA engines and control information that are included in this embodiment for the I/O processing illustrated in FIG. 3.

FIG. 4 is a diagram for illustrating the internal configuration of the NVMe DMA engine 160 in this embodiment. The NVMe DMA engine 160 is a DMA engine configured to execute command processing together with the host apparatus 2 through the SQT doorbell 1611 and the CQHD doorbell 1621.

The NVMe DMA engine 160 includes a command block (CMD_BLK) 1610 configured to process command reception, which is the first phase, a completion block (CPL_BLK) 1620 configured to return a completion notification (completion) to the host apparatus 2 after the command processing, a command manager (CMD_MGR) 1630 configured to control the two blocks and to handle communication to/from the control software running on the processor, and a command determination block (CMD_JUDGE) 1640 configured to perform a format validity check on a received command and to identify the command type. While the NVMe DMA engine 160 in this embodiment has the above-mentioned block configuration, this configuration is an example and other configurations may be employed as long as the same functions are implemented. The same applies to the other DMA engines included in this embodiment.

The CMD_BLK 1610 includes the submission queue tail (SQT) doorbell register 1611 described above, a current head register 1612 configured to store an entry number that is being processed at present in order to detect a difference from the SQT doorbell register 1611, a CMD DMA engine 1613 configured to actually obtain a command, and an internal buffer 1614 used when the CMD DMA engine 1613 obtains a command.

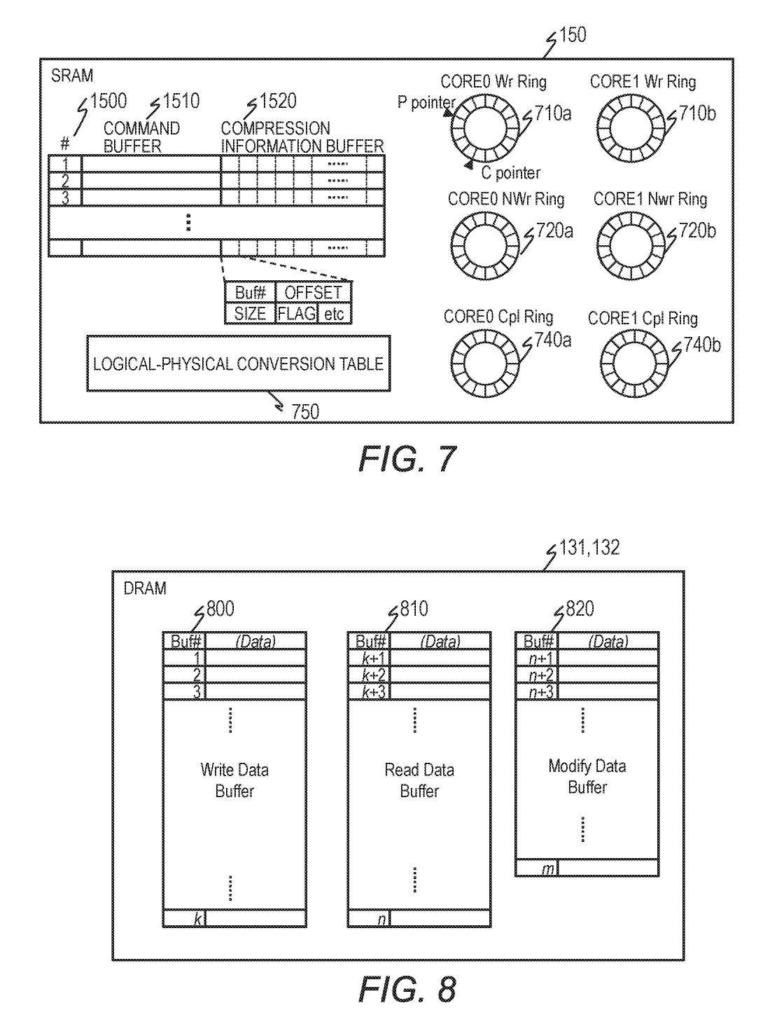

The CPL_BLK 1620 includes a CPL DMA engine 1623 configured to generate and issue completion to the host apparatus 2 when instructed by the CMD_MGR 1630, a buffer 1624 used in the generation of completion, the completion queue head doorbell (CQHD) register 1621 described above, and a current tail register 1622 provided for differential detection of an update to the CQHD doorbell register 1621. The CPL_BLK 1620 also includes a table 1625 configured to store an association relation between an entry number of the completion queue and a command number 1500 (described later with reference to FIG. 7), which is used in internal processing. The CMD_MGR 1630 uses the table 1625 and a completion reception notification from the host apparatus 2 to manage the completion situation of a command.

The CMD_BLK 1610 and the CPL_BLK 1620 are coupled to the PCIe core 110 through the bus 200, and can hold communication to and from each other.

The CMD_BLK 1610 and the CPL_BLK 1620 are also coupled internally to the CMD_MGR 1630. The CMD_MGR 1630 instructs the CPL_BLK 1620 to generate a completion response when a finish notification or an error notification is received from the control software or other DMA engines, and also manages empty slots in a command buffer that is provided in the SRAM 150 (this command buffer is described later with reference to FIG. 7). The CMD_MGR 1630 manages the empty slots based on a buffering request from the CMD_BLK 1610 and a buffer releasing notification from the processor. The CMD_JUDGE 1640 is coupled to the CMD_BLK 1610, and is placed on a path along which a obtained command is transferred to a command buffer of the DRAM 131. When a command passes through the CMD_JUDGE 1640, the CMD_JUDGE 1640 identifies the type of the command (whether the passing command is a read command, a write command, or of other types), and checks the command format and values in the command format for a deviation from standards. The CMD_JUDGE 1640 is also coupled to the PARAM DMA engine 170, which is described later, via the control signal line 230 in order to activate the PARAM DMA engine 170 depending on the result of the command type identification. The CMD_JUDGE 1640 is coupled to the CMD_MGR 1630 as well in order to return an error response to the host apparatus 2 in a case where the command format is found to be invalid (the connection is not shown)

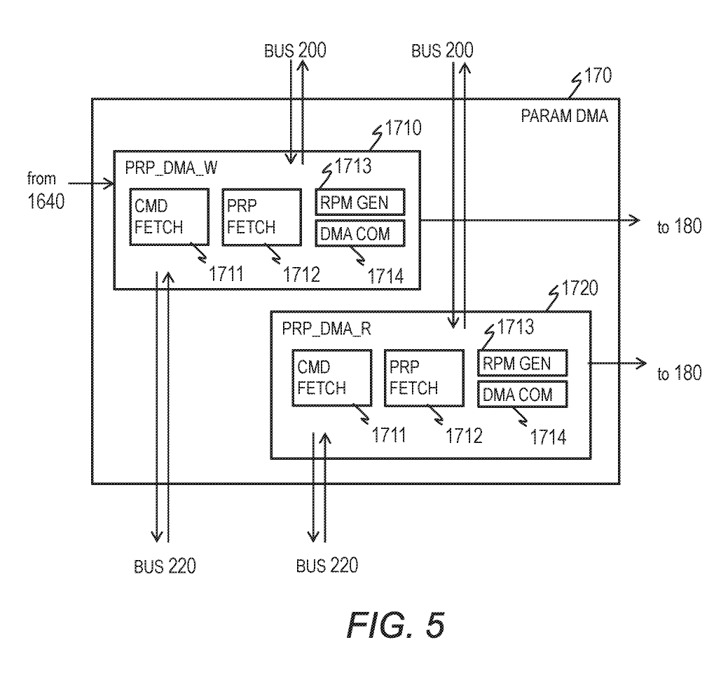

FIG. 5 is a diagram for illustrating the internal configuration of the PARAM DMA engine 170 in this embodiment. The PARAM DMA engine 170 is a DMA engine configured to generate transfer parameters necessary to activate the DATA DMA engine 180 by analyzing parameters which are included in a command that the CMD_BLK 1610 has stored in the command buffer of the DRAM 131.

The PARAM DMA engine 170 includes PRP_DMA_W 1710, which is activated by the CMD_JUDGE 1640 in the CMD_BLK 1610 in a case where a command issued by the host apparatus 2 is a write command, and PRP_DMA_R 1720, which is activated by the processor 140 when read return data is ready, in a case where a command issued by the host apparatus 2 is a read command. The suffixes “_W” and “_R” correspond to different types of commands issued from the host apparatus 2, and the block having the former (_W) is put into operation when a write command is processed, whereas the block having the latter (_R) is put into operation when a read command is processed.

The PRP_DMA_W 1710 includes a CMD fetching module (CMD_FETCH) 1711 configured to obtain necessary field information from a command and to analyze the field information, a PFP fetching module (PRP_FETCH) 1712 configured to obtain PRP entries through analysis, a parameter generating module (PRM_GEN) 1713 configured to generate DMA parameters based on PRP entries, DMA_COM 1714 configured to handle communication to and from the DMA engine, and a buffer (not shown) used by those modules.

The PRP_DMA_R 1720 has a similar configuration, and includes CMD_FETCH 1721, PRP_FETCH 1722, PRM_GEN 1723, DMA_COM 1724, and a buffer used by those modules.

The PRP_DMA_W 1710 and the PRP_DMA_R 1720 are coupled to the bus 200 in order to obtain a PRP entry list from the host apparatus 2, and are coupled to the bus 220 as well in order to refer to command information stored in the command buffer on the SRAM 150. The PRP_DMA_W 1710 and the PRP_DMA_R 1720 are also coupled to the DATA DMA engine 180, which is described later, via the control signal line 240 in order to instruct data transfer by DMA transfer parameters that the blocks 1710 and 1720 generate.

The PRP_DMA_W 1710 is further coupled to the CMD_JUDGE 1640, and is activated by the CMD_JUDGE 1640 when it is a write command that has been issued.

The PRP_DMA_R 1720, on the other hand, is activated by the processor 140 via the bus 220 after data to be transferred to the memory 20 of the host apparatus 2 is prepared in a read buffer that is provided in the DRAMs 131 and 132. The connection to the bus 220 also is used for holding communication to and from the processor 140 and the CMD_MGR in the event of a failure.

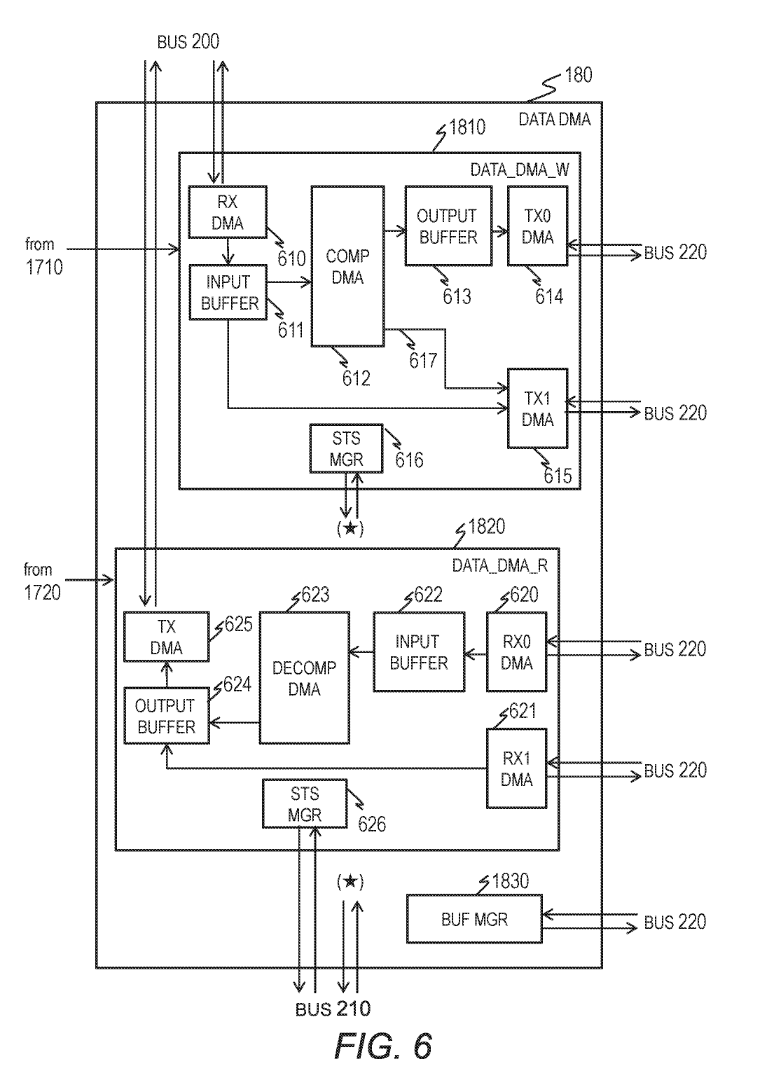

FIG. 6 is a diagram for illustrating the internal configuration of the DATA DMA engine 180 in this embodiment. The DATA DMA engine 180 includes DATA_DMA_W 1810 configured to transfer compressed or non-compressed data from the memory 20 of the host apparatus 2 to a write buffer that is provided in the DRAMs 131 and 132 of the device 1, based on DMA transfer parameters that are generated by the PRP_DMA_W 1710, and DATA_DMA_R 1820 configured to operate mainly in read command processing of the host apparatus 2 through a function of transferring decompressed or non-decompressed data from the read buffer provided in the DRAMs 131 and 132 to the memory 20 of the host apparatus 2, based on DMA transfer parameters that are generated by the PRP_DMA_R 1720. The symbol “_W” or “_R” at the end is meant to indicate the I/O type from the standpoint of the host apparatus 2.

The DATA_DMA_W 1810 includes an RX_DMA engine 610 configured to read data out of the memory 20 of the host apparatus 2 in order to process a write command, an input buffer 611 configured to store the read data, a COMP DMA engine 612 configured to read data out of the input buffer in response to a trigger pulled by the RX_DMA engine 610 and to compress the data depending on conditions about whether or not there is a compression instruction and whether a unit compression size is reached, an output buffer 613 configured to store compressed data, a status manager STS_MGR 616 configured to perform management for handing over the compression size and other pieces of information to the processor when the operation of the DATA_DMA_W 1810 is finished, a TX0 DMA engine 614 configured to transmit compressed data to the DRAMs 131 and 132, and a TX1 DMA engine 615 configured to transmit non-compressed data to the DRAMs 131 and 132. The TX1 DMA engine 615 is coupled internally to the input buffer 611 so as to read non-compressed data directly out of the input buffer 611.

The TX0_DMA engine 614 and the TX1_DMA engine 615 may be configured as one DMA engine. In this case, the one DMA engine couples the input buffer and the output buffer via a selector.

The COMP DMA engine 612 and the TX1 DMA engine 615 are coupled by a control signal line 617. In a case where a command from the host apparatus instructs to compress data, the COMP DMA engine 612 compresses the data. In a case where a given condition is met, on the other hand, the COMP DMA engine 612 instructs the TX1 DMA 615 to transfer non-compressed data via the control signal line 617 in order to transfer data without compressing the data. The COMP DMA engine 612 instructs non-compressed data transfer when, for example, the terminating end of data falls short of the unit of compression, or when the post-compression size is larger than the original size.

The DATA_DMA_R 1820 includes an RX0_DMA engine 620 configured to read data for decompression out of the DRAMs 131 and 132, an RX1_DMA engine 621 configured to read data for non-decompression out of the DRAMs 131 and 132, an input buffer 622 configured to store read compressed data, a DECOMP DMA engine 623 configured to read data out of the input buffer and to decompress the data depending on conditions, a status manager STS_MGR 626 configured to manage compression information, which is handed from the processor, in order to determine whether or not the conditions are met, an output buffer 624 configured to store decompressed and non-decompressed data, and a TX_DMA engine 625 configured to write data to the memory 20 of the host apparatus 2.

The RX1_DMA engine 621 is coupled to the output buffer 624 so that compressed data can be written to the host apparatus 2 without being decompressed. The RX0_DMA engine 620 and the RX1_DMA engine 621 may be configured as one DMA engine. In this case, the one DMA engine couples the input buffer and the output buffer via a selector.

The DATA_DMA_W 1810 and the DATA_DMA_R 1820 are coupled to the bus 200 in order to access the memory 20 of the host apparatus 2, are coupled to the bus 210 in order to access the DRAMs 131 and 132, and are coupled to the bus 220 in order to hold communication to and from the CPL_BLK 1620 in the event of a failure. The PRP_DMA_W 1710 and the DATA_DMA_W 1821 are coupled to each other and the PRP_DMA_R 1720 and the DATA_DMA_R 1820 are coupled to each other in order to receive DMA transfer parameters that are used to determine whether or not the components are put into operation.

FIG. 7 is an illustration of all the described pieces of information that are put on the SRAM 150 in this embodiment. The SRAM 150 includes a command buffer 1510 configured to store command information that is received from the host apparatus 2 and used by the CMD_DMA 1613 and other components, and a compression information buffer 1520 configured to store compression information on the compression of data about which the received command has been issued. The command buffer 1510 and the compression information buffer 1520 are managed with the use of the command number 1500. The SRAM 150 also includes write command ring buffers Wr rings 710a and 710b configured to store command numbers in order for the CMD_DMA 1613 to notify the reception of a write command and data to the processor cores 140a and 140b, non-write command ring buffers NWr rings 720a and 720b similarly configured to store command numbers in order to notify the reception of a read command or other types of commands, completion ring buffers Cpl rings 740a and 740b configured to store command numbers in order to notify that the reception of a completion notification from the host apparatus 2 has been completed, and a logical-physical conversion table 750 configured to record an association relation between a physical address on an FM and a logical address shown to the host apparatus 2. The SRAM 150 is also used as a work area of the control software running on the processor 140, which, however, is irrelevant to the specifics of this invention. A description thereof is therefore omitted.

The command buffer 1510 includes a plurality of areas for storing NVMe commands created in entries of the submission queue and obtained from the host apparatus 2. Each of the areas has the same size and is managed with the use of the command number 1500. Accordingly, when a command number is known, hardware can find out an access address of an area in which a command associated with the command number is stored by calculating “head address+command number×fixed size”. The command buffer 1510 is managed by hardware, except a partial area reserved for the processor 140. The compression information buffer 1520 is provided for each command, and is configured so that a plurality of pieces of information can be stored for each unit of compression in the buffer. For example, in a case where the maximum transfer length is 256 KB and the unit of compression is 4 KB, the compression information buffer 1520 is designed so that sixty-four pieces of compression information can be stored in one compression buffer. How long the maximum transfer length supported is to be is the matter of design. The I/O size demanded by application software on the host apparatus, which often exceeds the maximum transfer length (for example, 1 MB is demanded), is divided among drivers (for example, 256 KB×4) in most cases.

Compression information stored for each unit of compression in the compression buffer 1520 includes, for example, a data buffer number, which is described later, a data buffer number, an offset in the data buffer, a post-compression size, and a valid/invalid flag of the data in question. The valid/invalid flag of the data indicates whether or not the data in question has become old data and unnecessary due to the arrival of update data prior to the writing of the data to a flash memory. Other types of information necessary for control may also be included in compression information if there are any. For example, data protection information, e.g., a T10 DIF, which is often attached on a sector-by-sector basis in storage, may be detached and left in the compression information instead of being compressed. In a case where 8 B of T10 DIF is attached to 512 B of data, the data may be compressed in units of 512 B×four sectors, with 8 B×four sectors of T10 DIF information recorded in the compression information. In a case where sectors are 4,096 B and 8 B of T10 DIF is attached, 4,096 B are compressed and 8 B are recorded in the compression information.

The Wr rings 710a and 710b are ring buffers configured to store command numbers in order to notify the control software running on the processor cores 140a and 140b of the reception of a command and data at the DMA engines 160, 170, and 180 described above. The ring buffers 710a and 710b are managed with the use of a generation pointer (P pointer) and a consumption pointer (C pointer). Empty slots in each ring are managed by advancing the generation pointer each time hardware writes a command buffer number in the ring buffer, and advancing the consumption pointer each time a processor reads a command buffer number. The difference between the generation pointer and the consumption pointer therefore equals the number of newly received commands.

The NWr rings 720a and 720b and the Cpl rings 740a and 740b are configured the same way.

FIG. 8 is an illustration of the area management of data put on the DRAMs 131 and 132 in this embodiment. The DRAMs 131 and 132 include a write data buffer 800 configured to store write data, a read data buffer 810 configured to store data staged from the FMs, and a modify data buffer 820 used in RMW operation. Each buffer is managed in partitions having a fixed length. A number uniquely assigned to each partition is called a data buffer number, and each partition is treated as a data buffer. The size of each partition is, for example, 64 KB, and the number of data buffers that are associated with one command varies depending on data size.

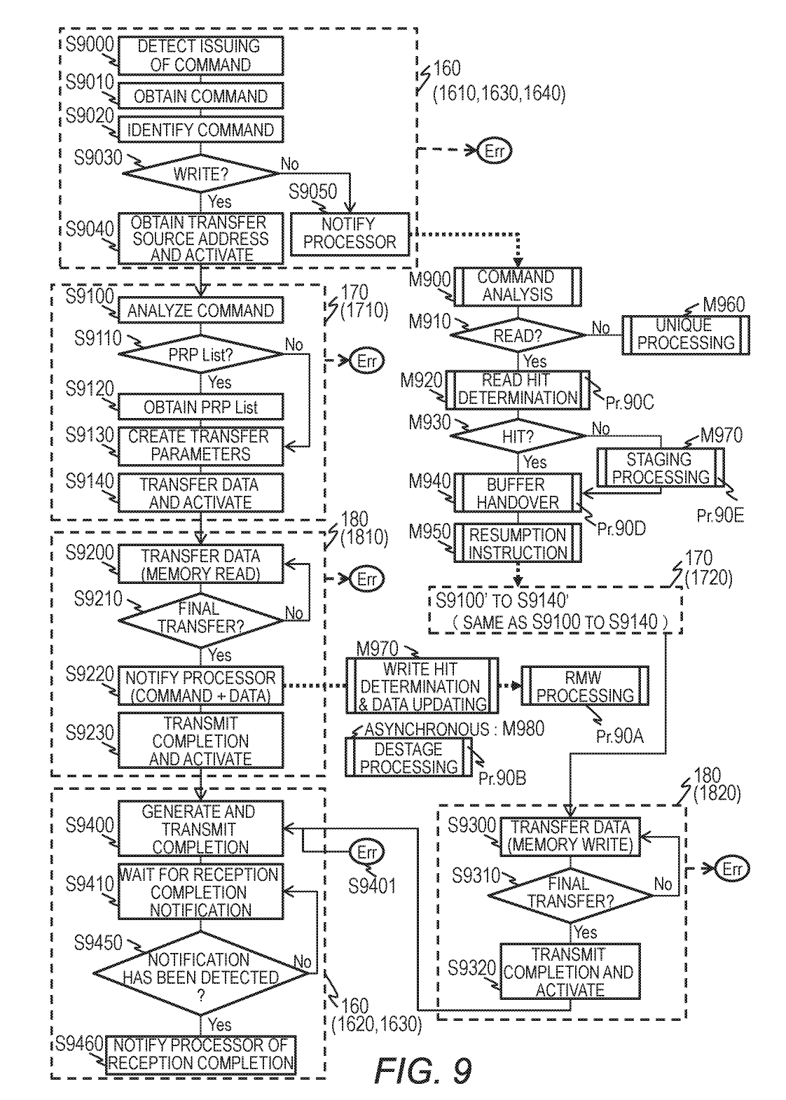

FIG. 9 is a flow chart for illustrating how the DMA engines 160, 170, and 180 cooperate with one another to perform processing in this embodiment. Each broken-line frame in the flow chart indicates the operation of one of the DMA engines, and each number with a prefix “S” in FIG. 9 represents the operation of hardware. As is commonly known, hardware operation includes waiting for an operation trigger to execute processing that is at the head of each broken-line frame and, after the trigger is pulled and a series of operation steps is finished, returns to waiting for the trigger for the head processing. The operation in each broken-line frame is therefore repeated each time the trigger is pulled, without waiting for the completion of the operation in the next broken-line frame. Parallel processing is accordingly accomplished by providing an independent DMA engine for each processing as in this embodiment. The purpose of FIG. 9 is to present an overview of the flow, and the repetition described above is not shown in FIG. 9. Activating a DMA engine in this embodiment means that the DMA engine starts a series of operation steps with the detection of a change in value or the reception of a parameter or other types of information as a trigger. Each number with a prefix “M” in FIG. 9, on the other hand, represents processing in the processor.

Details of the operation are described by first taking as an example a case where a write command is issued.

The host apparatus 2 queues a new command, updates the final entry number of the queue (the value of the tail pointer), and rings the SQT doorbell 1611. The NVMe DMA engine 160 then detects from the difference between the value of the current head register 1612 and the value of the SQT doorbell that a command has been issued, and starts the subsequent operation (S9000). The CMD_BLK 1610 makes an inquiry to the CMD_MGR 1630 to check for empty slots in the command buffer 1510. The CMD_MGR 1630 manages the command buffer 1510 by using an internal management register, and periodically searches the command buffer 1510 for empty slots. In a case where there is an empty slot in the command buffer 1510, the CMD_MGR 1630 returns the command number 1500 that is assigned to the empty slot in the command buffer to the CMD_BLK 1610. The CMD_BLK 1610 obtains the returned command number 1500, calculates an address in the submission queue 201 of the host apparatus 2 based on entry numbers stored in the doorbell register, and issues a memory read request via the bus 200 and the PCIe core 110, thereby obtaining the command stored in the submission queue 201. The obtained command is stored temporarily in the internal buffer 1614, and is then stored in a slot in the command buffer 1510 that is associated with the command number 1500 obtained earlier (S9010). At this point, the CMD_JUDGE 1640 analyzes the command being transferred and identifies the command (S9020). In a case where the command is a write command (S9030: Yes), the CMD_JUDGE 1640 sends the command number via the signal line 230 in order to execute steps up through data reception. The PRP_DMA_W 1710 in the PARAM_DMA engine 170 receives the command number and is activated (S9040).

Once activated, the PRP_DMA_W 1710 analyzes the command stored in a slot in the command buffer 1510 that is associated with the command number 1510 handed at the time of activation (S9100). The PRP_DMA_W 1710 then determines whether or not a PRP list needs to be obtained (S9110). In a case where it is determined that obtaining a PRP list is necessary, the PRP_FETCH 1712 in the PRP_DMA_W 1710 obtains a PRP list by referring to addresses in the memory 20 that are recorded in PRP entries (S9120). For example, in a case where a data transfer size set in the number-of-logical-blocks field 1906 is within an address range that can be expressed by two PRP entries included in the command, it is determined that obtaining a PRP list is unnecessary. In a case where the data transfer size is outside an address range that is indicated by PRPs in the command, it means that the command includes an address at which a PRP list is stored. The specific method of determining whether or not obtaining a PRP list is necessary, the specific method of determining whether an address recorded in a PRP entry is an indirect address that specifies a list or the address of a PRP, and the like are described in written standards of NVMe or other known documents.

When analyzing the command, the PRP_DMA_W 1720 also determines whether or not data compression or decompression is instructed.

The PRP_DMA_W 1710 creates transfer parameters for the DATA DMA engine 180 based on PRPs obtained from the PRP entries and the PRP list. The transfer parameters are, for example, a command number, a transfer size, a start address in the memory 20 that is the storage destination or storage source of data, and whether or not data compression or decompression is necessary. Those pieces of information are sent to the DATA_DMA_W 1810 in the DATA DMA 180 via the control signal line 240, and the DATA_DMA_W 1810 is activated (S9140).

The DATA_DMA_W 1810 receives the transfer parameters and first issues a request to a BUF_MGR 1830 to obtain the buffer number of an empty data buffer. The BUF_MGR 1830 periodically searches for empty buffers and buffers candidates. In a case where candidates are not depleted, the BUF_MGR 1830 notifies the buffer number of an empty buffer to the DATA_DMA_W 1810. In a case where candidates are depleted, the BUF_MGR 1830 keeps searching until an empty data buffer is found, and data transfer stands by for the duration.

The DATA_DMA_W 1810 uses the RX_DMA engine 610 to issue a memory read request to the host apparatus 2 based on the transfer parameters created by the PRP_DMA_W 1710, obtains write data located in the host apparatus 2, and stores the write data in its own input buffer 611. When storing the write data, the DATA_DMA_W 1810 sorts the write data by packet queuing and buffer sorting of known technologies because, while PCIe packets may arrive in random order, compression needs to be executed in organized order. The DATA_DMA_W 1810 determines based on the transfer parameters whether or not the data is to be compressed. In a case where the target data is to be compressed, the DATA_DMA_W 1810 activates the COMP DMA engine 612. The activated COMP DMA engine 612 compresses, as the need arises, data in the input buffer that falls on a border between units of management of the logical-physical conversion table and that has the size of the unit of management (for example, 8 KB), and stores the compressed data in the output buffer. The TX0_DMA engine 614 then transfers the data to the data buffer secured earlier, generates compression information, which is generated anew each time and which includes a data buffer number, a start offset, a transfer size, a data valid/invalid flag, and the like, and sends the compression information to the STS_MGR 616. The STS_MGR 616 collects the compression information in its own buffer and, each time the collected compression information reaches a given amount, writes the compression information to the compression information buffer 1520. In a case where the target data is not to be compressed, on the other hand, the DATA_DMA_W 1810 activates the TX1_DMA engine 615 and transfers the data to a data buffer without compressing the data. In the manner described above, the DATA_DMA_W 1810 keeps transferring to its own DRAMs 131 and 132 write data of the host apparatus 2 until no transfer parameter is left (S9200). In a case where the data buffer fills up in the middle of data transfer, a request is issued to the BUF_MGR 1830 each time and new buffer is used. A new buffer is thus always allocated for storage irrespective of whether or not there is a duplicate among logical addresses presented to the host apparatus 2, and update data is therefore stored in a separate buffer from its old data. In other words, old data is not overwritten in a buffer.

In a case where data falls short of the unit of compression at the head and tail of the data, the COMP DMA engine 612 activates the TX1_DMA engine 615 with the use of the control signal line 617, and the TX1_DMA engine 615 transfers data non-compressed out of the input buffer to a data buffer in the relevant DRAM. The data is stored non-compressed in the data buffer, and the non-compressed size of the data is recorded in compression information of the data. This is because data that falls short of the unit of compression requires read modify write processing, which is described later, and, if compressed, needs to be returned to a decompressed state. Such data is stored without being compressed in this embodiment, thereby deleting unnecessary decompression processing and improving processing efficiency.

In a case where the size of compressed data is larger than the size of the data prior to compression, the COMP DMA engine 612 similarly activates the TX1 DMA engine 615 and the TX1 DMA engine 615 transfers non-compressed data to a data buffer. More specifically, the COMP DMA engine 612 counts the transfer size when post-compression data is written to the output buffer 613 and, in a case where transfer is not finished at the time the transfer size reaches the size of the data non-compressed, interrupts the compression processing and activates the TX1_DMA engine 615. Storing data that is larger when compressed can be avoided in this manner. In addition, delay is reduced because the processing is switched without waiting for the completion of compression.

In a case where it is final data transfer for the command being processed (S9210: Yes), after the TX0_DMA engine 614 finishes data transmission, the STS_MGR 616 writes remaining compression information to the compression information buffer 1520. The DATA_DMA_W 1810 notifies the processor that the reception of the command and data has been completed by writing the command number in the Wr ring 71 of the relevant core and advancing the generation pointer by 1 (S9220).

Which processor core 140 is notified with the use of one of the Wr rings 710 can be selected by any of several possible selection methods including round robin, load balancing based on the number of commands queued, and selection based on the LBA range.

When the arrival of a command in one of the Wr rings 710 is detected by polling, the processor 140 obtains compression information based on the command number stored in the ring buffer to record the compression information in the management table of the processor 140, and refers to the specifics of a command that is stored in a corresponding slot in the command buffer 1510. The processor 140 then determines whether or not the write destination logical address of this command is already stored in another buffer slot, namely, whether or not it is a write hit (M970).

In a case where it is a write hit and the entirety of old data can be overwritten, there is no need to write old data stored in one of the DRAMs to a flash memory, and a write invalidation flag is accordingly set to compression information that is associated with the old data (still M970). In a case where the old data and the update data partially overlap, on the other hand, the two need to be merged (modified) into new data. The processor 140 in this case creates activation parameters based on the compression information, and sends the parameters to the RMW_DMA engine 190 to activate the RMW_DMA engine 190. Details of this processing are described later in a description given on Pr.90A.

In a case of a write miss, on the other hand, the processor 140 refers to the logical-physical conversion table 750 to determine whether the entirety of old data stored in one of the flash memories can be overwritten with the update data. In a case where the entirety of the old data can be overwritten, the old data is invalidated by a known flash memory control method when the update data is destaged (wirtten) to the flash memory (M970). In a case where the old data and the update data partially overlap, on the other hand, the two need to be merged (modified) into new data. The processor 140 in this case controls the FMC DMA engine 120 to read data out of a flash memory area that is indicated by the physical address in question. The processor 140 stores the read data in the read data buffer 810. The processor 140 reads compression information that is associated with the logical address in question out of the logical-physical conversion table 750, and stores the compression information and the buffer number of a data buffer in the read data buffer 810 in the compression information buffer 1520 that is associated with the command number 1500. Thereafter, the processor 140 creates activation parameters based on the compression information, and activates the RMV_DMA engine 190. The subsequent processing is the same as in Pr. 90A.

The processor 140 asynchronously executes destaging processing (M980) in which data in a data buffer is written to one of the flash memories, based on a given control rule. After writing the data in the flash memory, the processor 140 updates the logical-physical conversion table 750. In the update, the processor 140 stores compression information of the data as well in association with the updated logical address. A data buffer in which the destaged data is stored and a command buffer slot that has a corresponding command number are no longer necessary and are therefore released. Specifically, the processor 140 notifies a command number to the CMD_MGR 1630, and the CMD_MGR 1630 releases a command buffer slot that is associated with the notified command number. The processor 140 also notifies a data buffer number to the BUF_MGR 1830, and the BUF_MGR 1830 releases a data buffer that is associated with the notified buffer number. The released command buffer slot and data buffer are now empty and available for use in the processing of other commands. The timing of releasing the buffer is changed as the need arises to one suitable for the relation between processing optimization and completion transmission processing, which is described next, in the processor 140. The command buffer slot may be released by the CPL BLK 1620 instead after the completion transmission information.

In parallel to the processing described above, the DATA DMA engine 180 makes preparations to transmit, after the processor notification is finished, a completion message to the effect that data reception has been successful to the host apparatus 2. Specifically, the DATA DMA engine 180 sends a command number that has just been processed to the CPL_BLK 1620 in the NVMe DMA engine 160 via the control signal line 250, and activates the CPL_BLK 1620 (S9400).

The activated CPL_BLK 1620 refers to command information stored in a slot in the command buffer 1510 that is associated with the received command number 1500, generates completion in the internal buffer 1624, writes the completion in an empty entry of the completion queue 202, and records the association between the entry number of this entry and the received command number in the association table included in the internal buffer 1624 (S9400). The CPL_BLK 1620 then waits for a reception completion notification from the host apparatus 2 (S9410). When the host apparatus 2 returns a completion notification reception (FIG. 3: S350) (S9450), it means that this completion transmission has succeeded, and the CPL_BLK 1620 therefore finishes processor notification by referring the association table for the recorded association between the entry number and the command number, and writing the found command number in one of the Cpl rings 740 (S9460).

Details of the operation in a case of non-write commands, which include read commands, are described next with reference to FIG. 9. The operation from Step S9000 through Step S9020 is the same as in a case of write commands, and Step S9030 and subsequent steps are therefore described.

In a case where it is found as a result of the command identification that the issued command is not a write command (S9030: No), the CMD_DMA engine 1613 notifies the processor 140 by writing the command number in the relevant NWr ring (S9050).

The processor detects the reception of the non-write command by polling the NWr ring, and analyzes a command that is stored in a slot in the command buffer 1510 that is associated with the written command number (M900). In a case where it is found as a result of the analysis that the analyzed command is not a read command (M910: No), the processor executes processing unique to this command (M960). Non-write commands that are not read commands are, for example, admin commands used in initial setting of NVMe and in other procedures.

In a case where the analyzed command is a read command, on the other hand (M910: No), the processor determines whether or not data that has the same logical address as the logical address of this command is found in one of the buffers on the DRAMs 131 and 132. In other words, the processor executes read hit determination (M920).

In a case where it is a read hit (M930: Yes), the processor 140 only needs to return data that is stored in the read data buffer 810 to the host apparatus 2. In a case where the data that is searched for is stored in the write data buffer 800, the processor copies the data in the write data buffer 800 to the read data buffer 810 managed by the processor 140, and stores, in the compression information buffer that is associated with the command number in question, the buffer number of a data buffer in the read data buffer 810 and information necessary for data decompression (M940). As the information necessary for data decompression, the compression information generated earlier by the compression DMA engine is used.

In a case where it is a read miss (M930: No), on the other hand, the processor 140 executes staging processing in which data is read out of one of the flash memories and stored in one of the DRAMs (M970). The processor 140 refers to the logical-physical conversion table 750 to identify a physical address that is associated with a logical address specified by the read command. The processor 140 then controls the FMC DMA engine 120 to read data out of a flash memory area that is indicated by the identified physical address. The processor 140 stores the read data in the read data buffer 810. The processor 140 also reads compression information that is associated with the specified logical address out of the logical-physical conversion table 750, and stores the compression information and the buffer number of a data buffer in the read data buffer 810 in the compression information buffer that is associated with the command number in question (M940).

While the found data is copied to the read data buffer in the description given above in order to avoid a situation where a data buffer in the write data buffer is invalidated/release by update write in the middle of returning read data, a data buffer in the write data buffer may be specified directly as long as lock management of the write data buffer can be executed properly.

After the buffer handover is completed, the processor sends the command number in question to the PRP_DMA_R 1720 in the PARAM DMA engine 170, and activates the PRP_DMA_R 1720 in order to resume hardware processing (M950).

The activated PRP_DMA_R 1720 operates the same way as the PRP_DMA_W 1710 (S9100 to S9140), and a description thereof is omitted. The only difference is that the DATA_DMA_R 1820 is activated by the operation of Step S9140′.

The activated DATA 1820 uses the STS_MGR 626 to obtain compression information from the compression information buffer that is associated with the received command number. In a case where information instructing decompression is included in the transfer parameters, this information is used to read the data in question out of the read data buffer 810 and decompress the data. The STS_MGR 626 obtains the compression information, and notifies the buffer number of a data buffer in the read data buffer and offset information that are written in the compression information to the RX0_DMA engine. The RX0_DMA engine uses the notified information to read data stored in the data buffer in the read data buffer that is indicated by the information, and stores the read data in the input buffer 622. The input buffer 622 is a multi-stage buffer and stores the data one unit of decompression processing at a time based on the obtained compression information. The DECOMP DMA engine 623 is notified each time data corresponding to one unit of decompression processing is stored. Based on the notification, the DECOMP DMA engine 623 reads compressed data out of the input buffer to decompress the read data, and stores the decompressed data in the output buffer. When a prescribed amount of data accumulates in the output buffer, the TX_DMA engine 625 issues a memory write request to the host apparatus 2 via the bus 200, based on transfer parameters generated by the PRP_DMA_R 1720, to thereby store data of the output buffer in a memory area specified by PRPs (S9300).

When the data transfer by the TX_DMA engine 625 is all finished (S9310: Yes), the DATA_DMA_R 1820 (the DATA DMA engine 180) sends the command number to and activates the CPL_BLK 1620 of the NVMe DMA engine 160 in order to transmit completion to the host apparatus 2. The subsequent operation of the CPL_BLK is the same as in the write command processing.

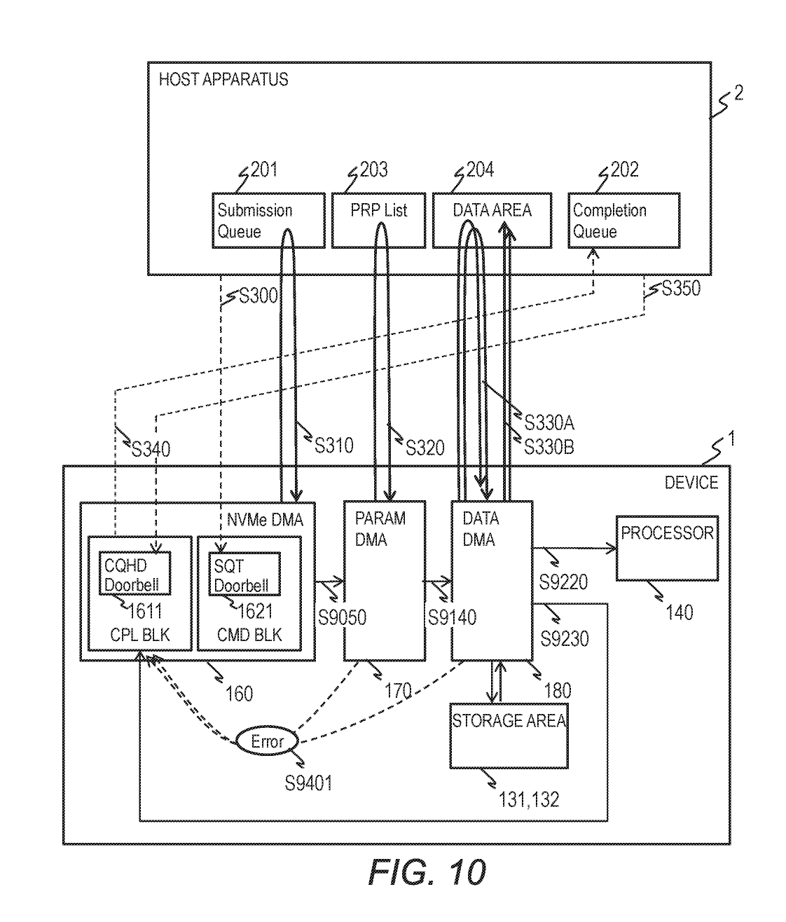

FIG. 10 is a diagram for schematically illustrating the inter-DMA engine cooperation processing in FIG. 9 and notification processing that is executed among DMA engines in the event of a failure. When there is no trouble, each DMA engine activates the next DMA engine. In a case where a failure or an error is detected, an error notification function Err (S9401) is used to notify the CPL BLK 1620 and the current processing is paused. The CPL BLK 1620 transmits completion (S340) along with the specifics of the notified error, thereby notifying the host apparatus 2. In this manner, notification operation can be executed when there is a failure without the intervention of the processor 140. In other words, the load on the processor 140 that is generated by failure notification is reduced and a drop in performance is prevented.

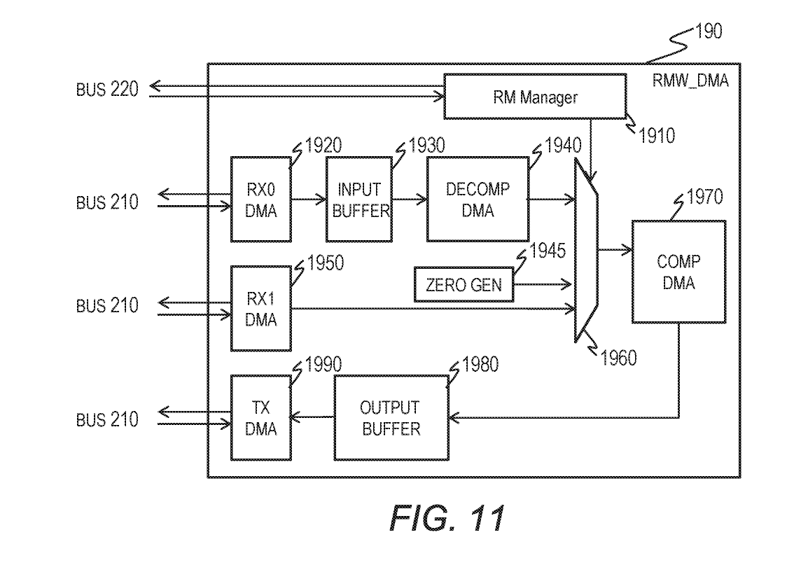

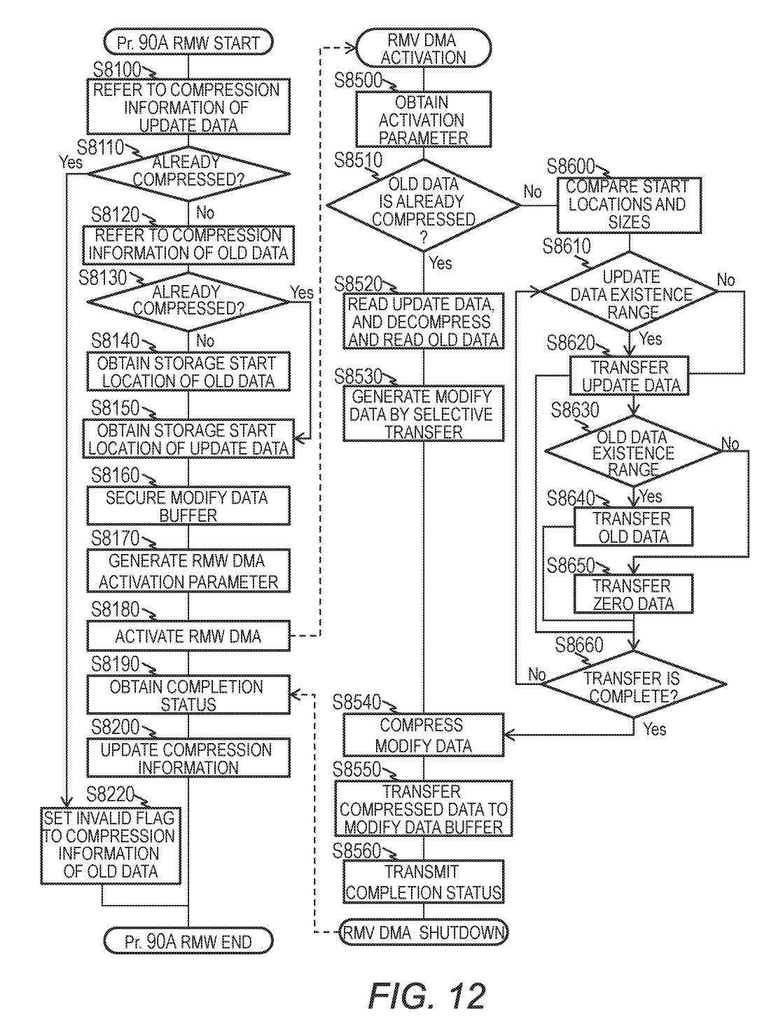

Read modify write processing in this embodiment is described next with reference to FIG. 11 and FIG. 12.

One of scenes where the presence of a cache in a storage device or in a server is expected to help is a case where randomly accessed small-sized data is cached. In this case, data that arrives does not have consecutive addresses in most cases because data is random. Consequently, in a case where the size of update data is smaller than the unit of compression, read-modify occurs frequently between the update data and compressed and stored data.

In read-modify of the related art, the processor reads compressed data out of a storage medium onto a memory, decompresses the compressed data with the use of the decompression DMA engine, merges (i.e., modifies) the decompressed data and the update data stored non-compressed, stores the modified data in the memory again, and then needs to compress the modified data again with the use of the compression DMA engine. The processor needs to create a transfer list necessary to activate a DMA engine each time, and needs to execute DMA engine activating processing and completion status checking processing, which means that an increase in processing load is unavoidable. The increase in processing load is caused by a drop in processing performance due to increased memory access. The read-modify processing of compressed data is accordingly heavier in processing load and larger in performance drop than in normal read-modify processing. For that reason, this embodiment accomplishes high-speed read modify write processing that is reduced in processor load and memory access as described below.

FIG. 11 is a block diagram for illustrating the internal configuration of the RMW DMA engine 190, which executes the read modify write processing in the Pr. 90A described above.

The RMW_DMA engine 190 is coupled to the processor through the bus 220, and is coupled to the DRAMs 131 and 132 through the bus 210.

The RMW_DMA engine 190 includes an RX0_DMA engine 1920 configured to read compressed data out of the DRAMs, an input buffer 1930 configured to temporarily store the read data, a DECOMP DMA engine 1940 configured to read data out of the input buffer 1930 and to decompress the data, and an RX1_DMA engine 1950 configured to read non-compressed data out of the DRAMs. The RMW DMA engine 190 further includes a multiplexer (MUX) 1960 configured to switch data to be transmitted depending on the modify part and to discard the other data, ZERO GEN 1945 selected when the MUX 1960 transmits zero data, a COMP DMA engine 1970 configured, to compress transmitted data again, an output buffer 1980 to which the compressed data is output, and a TX_DMA engine 1990 configured to write back the re-compressed data to one of the DRAMs. An RM manager 1910 controls the DMA engines and the MUX based on activation parameters that are given by the processor at the time of activation.

The RMW DMA engine 190 is activated by the processor, which is coupled to the bus 220, at the arrival of the activation parameters. The activated RMW DMA engine 190 analyzes the parameters, uses the RX0_DMA engine 1920 to read compressed data that is old data out of a data buffer of the DRAM 131, and instructs the RX1_DMA 1950 to read non-compressed data that is update data.

When the transfer of the old data and the update data is started, the RM manager 1910 controls the MUX 1960 in order to create modified data based on instructions of the activation parameters. For example, in a case where 4 KB of data following first 513 B out of 32 KB of decompressed data needs to be replaced with the update data, the RM manager instructs the MUX 1960 to allow 512 B of the old data decompressed by the DECOMP_DMA engine 1940 to pass therethrough, and instructs the RX1 DMA 1950 to suspend transfer for the duration. After 512 B of the data passes through the MUX 1960, the RM manager 1910 instructs the MUX 1960 to allow data that is transferred from the RX1_DMA 1950 to pass therethrough this time, while discarding data that is transferred from the DECOMP_DMA engine 1940. After 4 KB of the data passes through the MUX 1960, the RM manager again instructs the MUX 1960 to allow data that is transferred from the DECOMP DMA engine 1940 to pass therethrough.

Through the transfer described above, new update data generated by rewriting 4 KB following first 513 B of the old data, which is 32 KB in total, is sent to the COMP_DMA 1970. When the sent data arrives, the COMP_DMA 1970 compresses the data on a compression unit-by-compression unit basis, and stores the compressed data in the output buffer 1980. The TX_DMA engine 1990 transfers the output buffer to a data buffer that is specified by the activation parameters. The RMW_DMA engine executes compression operation in the manner described above.

In a case where there is a gap (a section with no data) between two pieces of modify data, the RN manager 1920 instructs the MUX 1960 and the COMP_DMA 1970 to treat the gap as a period in which zero data is sent. The gap occurs when, for example, an update is made to 2 KB of data following the first byte and 1 KB of data following the first 5 B within a unit of storage of 8 KB to which update has never been made.

FIG. 12 is a flow chart for illustrating the operation of the processor and the RMW DMA engine 190 in the data update processing (RMW processing) of the Pr. 90A.

Data is compressed on a logical-physical conversion storage unit-by-logical-physical conversion storage unit basis, and the same unit can be used to overwrite data. Accordingly, the case where the merging processing is necessary in M970 is one of two cases: (1) the old data has been compressed and the update data is stored non-compressed in a size that falls short of the unit of compression, and (2) the old data and the update data are both stored non-compressed in a size that falls short of the unit of compression. Because the unit of storage is the unit of compression, in a case where the old data and the update data have both been compressed, the unit of storage can be used as the unit of overwrite and the modify processing (merging processing) is therefore unnecessary in the first place.

In a case of detecting, through polling, the arrival of a command at one of the Wr rings 710, the processor 140 starts the following processing.

The processor 140 first refers to compression information of the update data (S8100) and determines whether or not the update data has been compressed (S8110). In a case where the update data has been compressed (S8110: Yes), all parts of the old data that fall short of the unit of compression are overwritten with the update data, and the modify processing is accordingly unnecessary. The processor 140 therefore sets an invalid flag to corresponding parts of compression information of the old data (S8220), and ends the processing.

In a case where the update data is non-compressed (S8110: No), the processor 140 refers to compression information of the old data (S8120). Based on the compression information of the old data referred to, the processor 140 determines whether or not the old data has been compressed (S8130). In a case where the old data is non-compressed as well as the update data (S8130: No), the processor 140 checks the LBAs of the old data and the update data to calculate, for the old data and the update data each, a storage start location in the current unit of compression (S8140). In a case where the old data has been compressed (S8130: Yes), on the other hand, the storage start location of the old data is known as the head, and the processor 140 calculates the storage start location of the update data from the LBA of the update data (S8150).

The processor next secures in the modify data buffer 820 a buffer where modified data is to be stored (S8160). The processor next creates, in a given work memory area, activation parameters of the RMW DMA engine 190 from the compression information of the old data (the buffer number of a data buffer in the read data buffer 810 or in the write data buffer 800, storage start offset in the buffer, and the size), whether or not the old data has been compressed, the storage start location of the old data in the current unit of compression/storage which is calculated from the LBA, the compression information of the update data, the storage start location of the update data in the current unit of compression/storage which is calculated from the LBA, and the buffer number of the secured buffer in the modify data buffer 820 (S8170). The processor 140 notifies the storage address of the activation parameters to the RMW DMA engine 190, and activates the RMW DMA engine 190 (S8180).

The RMW DMA engine 190 checks the activation parameters (S8500) to determine whether or not the old data has been compressed (S8510). In a case where the old data is compressed data (S8510: Yes), the RMW DMA engine 190 instructs reading the old data out of the DRAM 131 by using the RX0 DMA engine 1920 and the DECOMP_DMA engine 1940, and instructs reading the update data out of the DRAM 131 by using the RX1 DMA engine 1950 (S8520). The RM manager 1910 creates modify data by controlling the MUX 1960 based on the storage start location information of the old data and the update data so that, for a part to be updated, the update data from the RX1 DMA engine 1950 is allowed to pass therethrough while the old data from the RX0 DMA engine 1920 that has been decompressed through the DECOMP_DMA engine 1940 is discarded, and so that, for the remaining part (the part not to be updated), the old data is allowed to pass therethrough (S8530). The RMW_DMA engine 190 uses the COMP DMA engine 1970 to compress transmitted data as the need arises (S8540), and stores the compressed data in the output buffer 1980. The RM manager 1910 instructs the TX DMA engine 1990 to store the compressed data in a data buffer in the modify data buffer 820 that is specified by the activation parameters (S8550). When the steps described above are completed, the RMW DMA engine 190 transmits a completion status that includes the post-compression size to the processor (S8560). Specifically, the completion status is written in a given work memory area of the processor.

In a case where the old data is not compressed data (S8510: No), the RMW DMA engine 190 compares the update data and the old data in storage start location and in size (S8600). When data is transferred from the RX1 DMA engine 1950 to the MUX 190 sequentially, starting from the storage start location, the RMW_DMA engine 190 determines whether or not the update data is present within the address range (S8610). In a case where the address range includes the update data (S8610: Yes), the RX1 DMA engine 1950 is used to transfer the update data. In a case where the address range does not include the update data (S8610: No), the RMW DMA engine 190 determines whether or not a part of the old data that does not overlap with the update data is present in the address range (S8630). In a case where the address range includes the part of the old data (S8630: Yes), the RMW DMA engine 190 uses the RX1 DMA engine 1950 to transfer the old data (S8640). In a case where the address range does not include the part of the old data (S8630: No), that is, when the address range does not include the update data and the old data, a switch is made so that the ZERO GEN 1945 is coupled, and zero data is transmitted to the COMP DMA engine 1970. The RMW DMA engine 190 uses the COMP_DMA engine 1970 to compress the data sent to the COMP_DMA 1970 (S8540), and uses the TX DMA engine 1990 to transfer, for storage, the compressed data to a data buffer in the modify data buffer 820 that is specified by the parameters (S8550). The subsequent processing is the same.

The processor 140 confirms the completion status, and updates the compression information in order to validate the data that has undergone the read modify processing. Specifically, an invalid flag is set to the compression information of the relevant block of the old data, while rewriting the buffer number of a write buffer and in-buffer start offset in the compression information of the relevant block of the update data with the buffer number (Buf#) of a data buffer in the modify data buffer 820 and the offset thereof. In a case where the data buffer in the write data buffer 800 that has been recorded before the rewrite can be released, the processor executes releasing processing, and ends the RMW processing.

In the manner described above, compression RMW is accomplished without needing the processor 140 to execute the writing of decompressed data to a DRAM and buffer securing/releasing processing that accompanies the writing, and to perform control on the activation/completion of DMA engines for re-compression. According to this invention, data that falls short of the unit of compression can be transferred in the same number of times of transfer as in the RMW processing of non-compressed data, and a drop in performance during RMW processing is therefore prevented. This makes the latency low and the I/O processing performance high, and reduces the chance of a performance drop in read-modify, thereby implementing a PCIe-SSD that is suitable for use as a cache memory in a storage device.

It is concluded from the above that, according to this embodiment, where DMA engines each provided for a different processing phase that requires access to the memory 20 are arranged in parallel to one another and can each execute direct transfer to the host apparatus 2 without involving other DMA engines, data transfer low in latency is accomplished.

In addition, this embodiment does not need the processor 140 to create transfer parameters necessary for DMA engine activation, to activate a DMA engine, and to execute completion harvesting processing, thereby reducing processing of the processor 140. Another advantage is that, interruption due to confirmation of the processor 140 and issue the next instruction for each transfer phase does not occur, hardware can operate efficiently. This means that the number of I/O commands that can be processed per unit time improves without enhancing the processor. As a result, the overall I/O processing performance of the device is improved and a low-latency and high-performance PCIe-SSD suitable for cache uses is implemented.

Modification examples of the first embodiment are described next. While the DATA DMA engine 180 transmits data to the host apparatus 2 in the first embodiment, another DMA engine configured to process data may additionally be called up in data transmission processing.

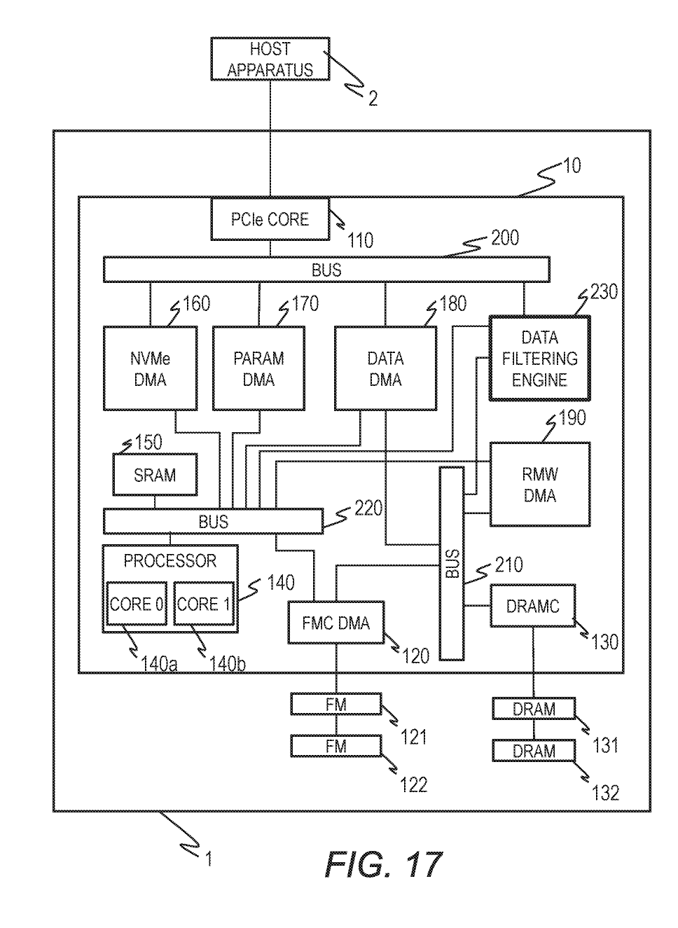

FIG. 17 is a diagram for illustrating Modification Example 1 of the first embodiment. In addition to the components of the first embodiment, a data filtering engine 230 is provided, which is configured to filter data by using a certain condition and then transmit the filtered data to the host apparatus 2. For example, the data filtering engine 230 obtains, from an address written in a PRP entry of a command, a secondary parameter in which a filtering condition and an address where filtering result data is to be stored are written, instead of PRPs. The data filtering engine 230 then extracts data that fits this secondary parameter condition from among data within the LBA range of the command.

In FIG. 9, the processor 140 executes processing unique to the issued command (M960) when the issued command is neither a read command nor a write command. In this modification example, when the issued command is recognized as, for example, a special command for data search, the processor 140 stages data indicated by the command from one of the flash memories to a data buffer in the read data buffer 810, and then uses the relevant command buffer number 1500 and the buffer number of the data buffer in the read data buffer 810 to activate the data filtering engine 230. The data filtering engine 230 refers to a command that is stored in a slot in the command buffer 1510 that is associated with the command buffer number 1500, and obtains a secondary parameter through the bus 200. The data filtering engine 230 filters data in the read data buffer 810 by using a filtering condition specified in the secondary parameter, and writes the result of the filtering to a data storage destination specified by the secondary parameter through the bus 200.

In this case also, DMA engines each provided for a different processing phase that require access to the host apparatus 2 are arranged in parallel to one another, which enables each DMA engine to execute direct transfer to the host apparatus 2 without involving other DMA engines. The device is also capable of selectively transmitting necessary data and eliminates waste transmission, thereby accomplishing high-performance data transfer.

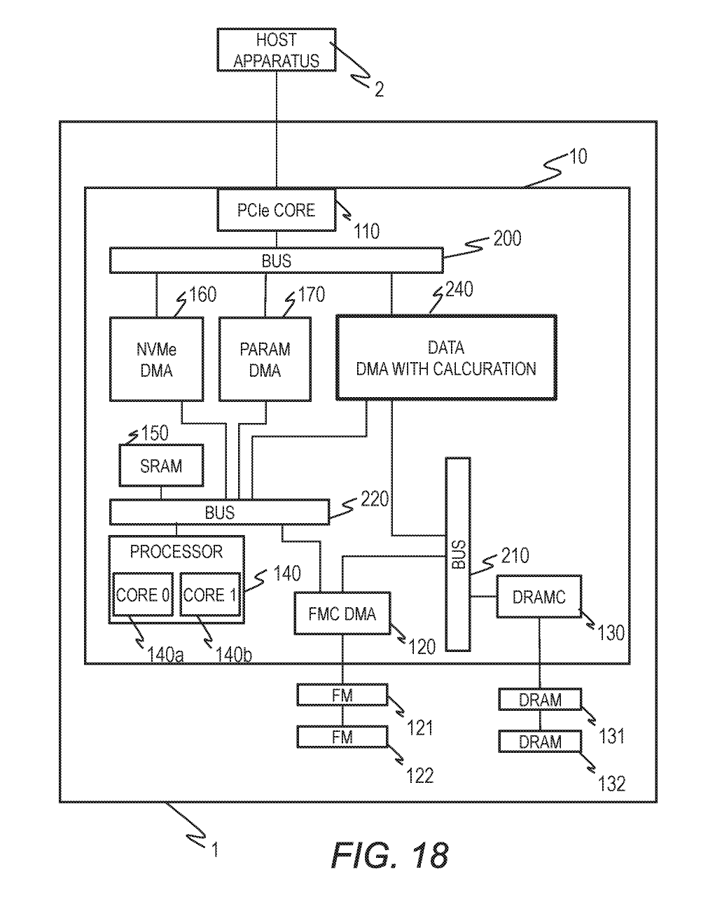

FIG. 18 is a diagram for illustrating Modification Example 2 of the first embodiment. A computation-use DMA engine, which is provided separately in Modification Example 1, may instead be unitary with the DATA DMA engine 180 as illustrated in FIG. 18. Processing that can be executed in this case besides filtering is, for example, calculating the sum or an average of numerical values that are values held in specific areas that are created by partitioning data into fixed lengths (records) while the data is being transmitted to the host apparatus 2.

By executing computation concurrently with data transfer, more information can be sent to the host apparatus without enhancing the processor. A cache device superior in terms of function is accordingly implemented.

### Second Embodiment

In the first embodiment, the basic I/O operation of the cache device 1 in this invention has been described.

The second embodiment describes cooperation between the cache device 1 and a storage controller, which is equivalent to the host apparatus 2 in the first embodiment, in processing of compressing data to be stored in an HDD, and also describes effects of the configuration of this invention.

The cache device 1 in this embodiment includes a post-compression size in notification information for notifying the completion of reception of write data to the processor 140 (S9460 of FIG. 9). The cache device 1 also has a function of notifying, at an arbitrary point in time, to the processor 140, the post-compression size of an LBA range about which an inquiry has been received.

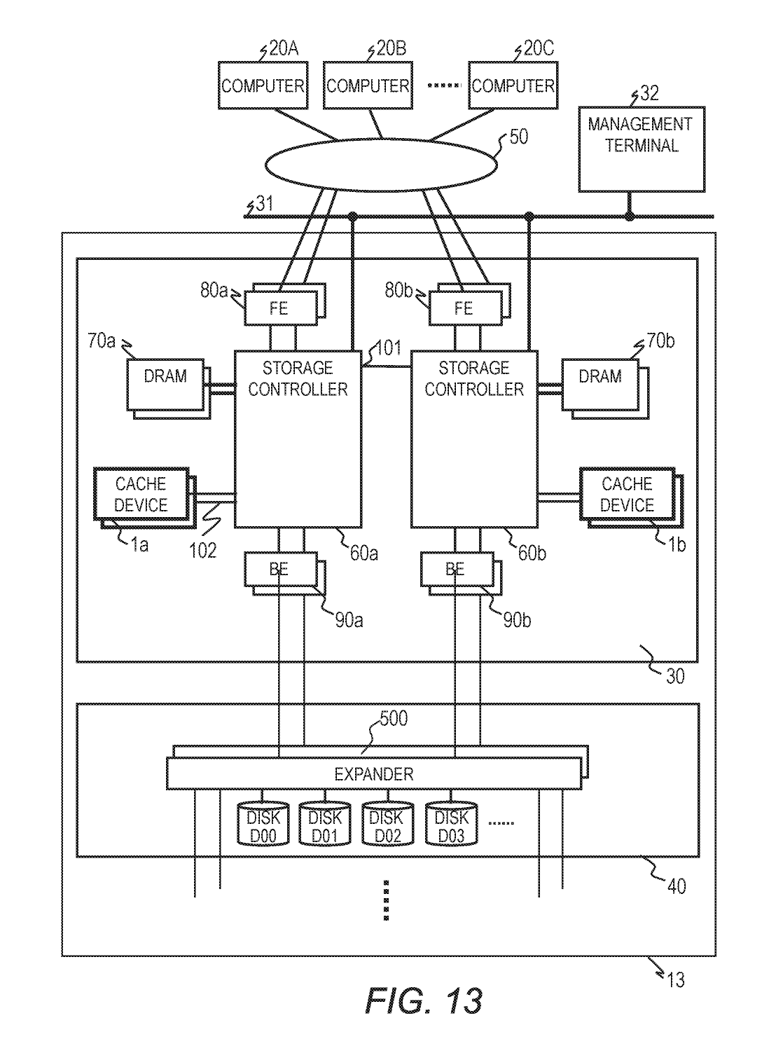

FIG. 13 is a block diagram for illustrating the configuration of a PCIe-connection cache device that is mounted in a storage device in this invention.

A storage device 13 is a device that is called a disk array system and that is coupled via a storage network 50 to host computers 20A to 20C, which use the storage device 13. The storage device 13 includes a controller casing 30 in which controllers are included and a plurality of disk casings 40 in which disks are included.

The controller casing 30 includes a plurality of storage controllers 60, here, 60a and 60b, made up of processors and ASICs, and the plurality of storage controllers 60 coupled by an internal network 101 in order to transmit/receive data and control commands to/from each other. In each of the disk casings 40, an expander 500, which is a mechanism configured to couple a plurality of disks, and a plurality of disks D, here, D00 to D03 are mounted. The disks D00 to D03 are, for example, SAS HDDs or SATA HDDs, or SAS SSDs or SATA SSDs.

The storage controller 60a includes a front-end interface adapter 80a configured to couple to the computers, and a back-end interface adapter 90a configured to couple to the disks. The front-end interface adapter 80a is an adapter configured to communicate by Fibre Channel, iSCSI, or other similar protocols. The back-end interface adapter 90a is an adapter configured to hold communication to and from HDDs by serial attached SCSI (SAS) or other similar protocols. The front-end interface adapter 80a and the back-end interface adapter 90a often have dedicated protocol chips mounted therein, and are controlled by a control program installed in the storage controller 60a.

The storage controller 60a further includes a DRAM 70a and a PCIe connection-type cache device 1a, which is the cache device of this invention illustrated in FIG. 1 and including flash memories. The DRAM 70a and the cache device 1a are used as data transfer buffers of the protocol chips and a disk cache memory managed by the storage control program. The cache device 1a is coupled to the storage controller 60a in the mode illustrated in FIG. 2A or FIG. 2B.

The storage controller 60a may include one or more cache devices 1a, one or more DRAMs 70a, one or more front-end interface adapters 80a, and one or more back-end interface adapters 90a. The storage controller 60b has the same configuration as that of the storage controller 60a (in the following description, the storage controllers 60a and 60b are collectively referred to as “storage controllers 60”). Similarly, one or more storage controllers 60 may be provided.

The mechanism and components described above that are included in the storage device 13 can be checked from a management terminal 32 through a management network 31, which is included in the storage device 13.

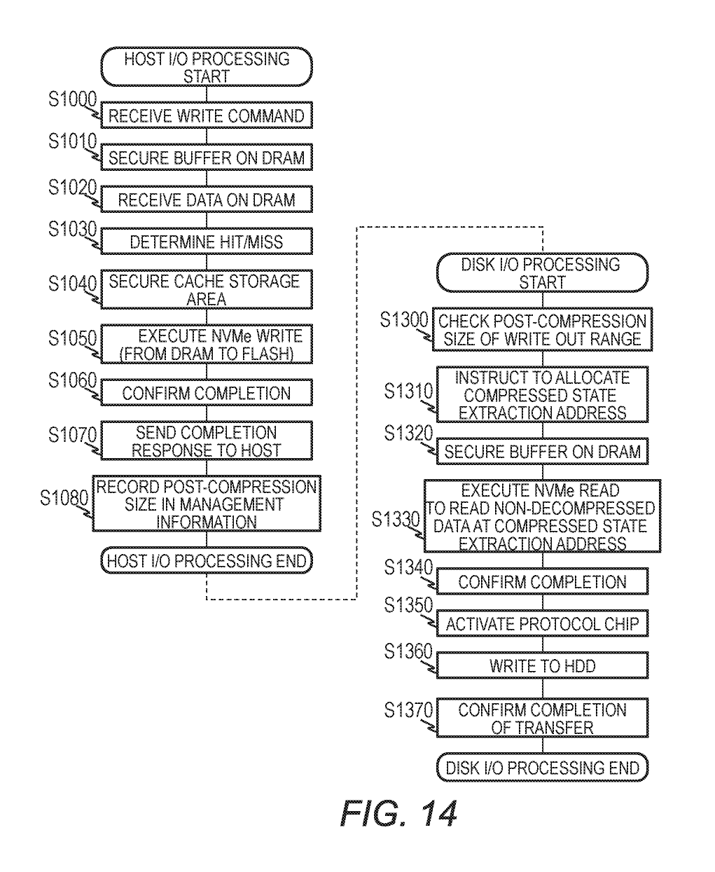

FIG. 14 is a flow chart for illustrating cooperation between the storage controllers 60 and the cache devices 1 that is observed when the storage device 13 processes write data from one of the host computers 20. The storage device 13 generally uses an internal cache memory to process write data by write back. The processing operation of each storage controller 60 therefore includes host I/O processing steps Step S1000 to Step S1080 up through the storing of data of a host computer 20 in a cache, and subsequent disk I/O processing steps Step S1300 to Step S1370 in which the storing of data from the cache to a disk is executed asynchronously. The processing steps are described below in order.

The storage controller 60 receives a write command from one of the host computers via the protocol chip that is mounted in the relevant front-end interface adapter 80 (S1000), analyzes the command, and secures a primary buffer area for data reception in one of the DRAMs 70 (S1010).

The storage controller 60 then transmits a data reception ready (XFER_RDY) message to the host computer 20 through the control chip, and subsequently receives data transferred from the host computer 20 in the DRAM 70 (S1020).

The storage controller 60 next determines whether or not data having the same address (LBA) is found on the cache devices 1 (S1030), in order to store the received data in a disk cache memory. Finding the data means a cache hit and not finding the data means a cache miss. In a case of a cache hit, the storage controller 60 sets an already allocated cache area as a storage area for the received data, in order to overwrite the found data, on the other hand, in a case of a cache miss, a new cache area is allocated as a storage area for the received data (S1040). Known methods of storage system control are used for the hit/miss determination and cache area management described above. Data is often duplicated between two storage controllers in order to protect data in a cache, and the duplication is executed by known methods as well.

The storage controller 60 next issues an NVMe write command to the relevant cache device 1 in order to store the data of the primary buffer in the cache device 1 (S1050). At this point, the storage controller 60 stores information that instructs to compress the data in the data set mgmt field 1907 of a command parameter in order to instruct the cache device 1 to compress the data.

The cache device 1 processes the NVMe write command issued earlier from the storage controller, by following the flow of FIG. 9 which is described in the first embodiment. To describe with reference to FIG. 3, the host apparatus 2 corresponds to the storage controller 60 and the data area 204 corresponds to the primary buffer. The cache device 1 compresses the data and stores the compressed data in one of the flash memories. After finishing a series of transfer steps, the cache device 1 generates completion in which status information including a post-compression size is included, and writes the completion in a completion queue of the storage controller.

The storage controller 60 detects the completion and executes the confirmation processing (notification, of completing receiving “completion”), which is illustrated in Step S350 of FIG. 3 (S1060). After finishing Step S1060, the storage controller 60 obtains the post-compression size from the status information and stores the post-compression size in a management table of the storage controller 60 (S1070). The storage controller 60 notifies the host computer 20 that data reception is complete (S1080), and ends the host I/O processing.

When a trigger for write in an HDD is pulled asynchronously with the host I/O processing, the storage controller 60 enters into HDD storage processing (what is called destaging processing) illustrated in Step S1300 to Step S1370. The trigger is, for example, the need to write data out of the cache area to a disk due to the depletion of free areas in the cache area, or the emergence of a situation in which RAID parity can be calculated without reading old data.

When writing data to a disk, processing necessary to parity calculation is executed depending on the data protection level, e.g., RAID 5 or RAID 6. The necessary processing is executed by known methods and is therefore omitted from the flow of FIG. 14, and only a part of the write processing that is a feature of this invention is described.

The storage controller 60 makes an inquiry to the relevant cache device 1 about the total data size of an address range out of which data is to be written to one of the disks, and obtains the post-compression size (S1300).

The storage controller 60 newly secures an address area that is large enough for the post-compression size and that is associated with the disk on which the compressed data is to be stored, and instructs the cache device 1 to execute additional address mapping so that the compressed data can be accessed from this address (S1310).

The cache device 1 executes the address mapping by adding a new entry to the flash memory's logical-physical conversion table 750, which is shown in FIG. 7.

The storage controller 60 next secures, on one of the DRAMs 70, a primary buffer in which the compressed data is to be stored (S1320). The storage controller 60 issues an NVMe read command with the use of a command parameter, in which information instructing to compress data is set, to the data set mgmt field 1907 so that the data is read compressed at the address mapped in Step S1310 (S1330). The cache device 1 transfers the read data to the primary buffer and transfers completion to the storage controller 60, by following the flow of FIG. 9.

The storage controller 60 confirms the completion and returns a reception notification to the cache device 1 (S1340). The storage controller 60 then activates the protocol chip in the relevant back-end interface adapter (S1350), and stores, in the disk, the compressed data that is stored in the primary buffer (S1360). After confirming the completion of the transfer by the protocol chip (S1370), the storage controller 60 ends the processing.

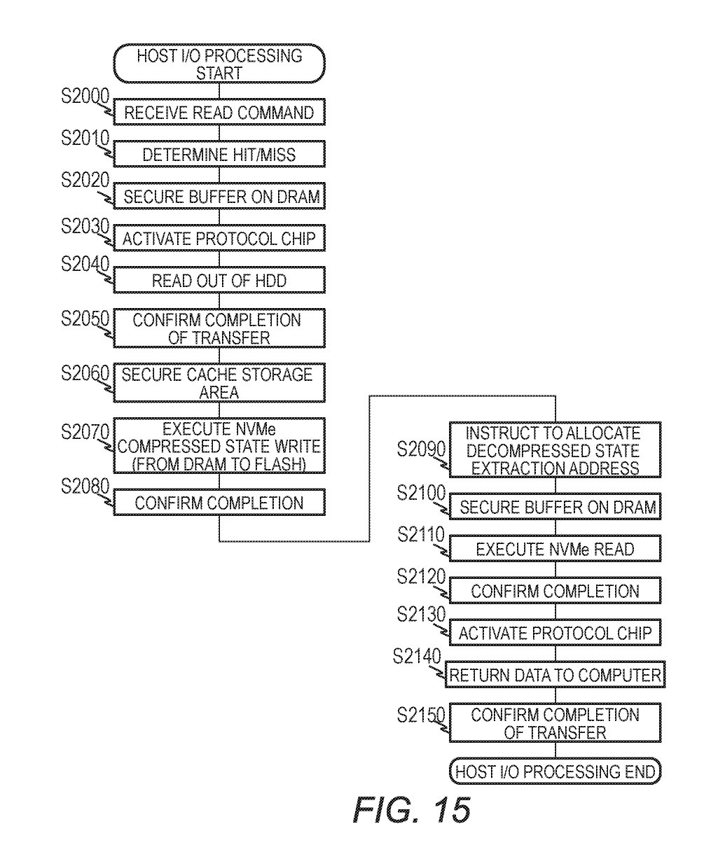

FIG. 15 is a flow chart for illustrating cooperation between the storage controllers 60 and the cache devices 1 that is observed when the storage device 13 processes a data read request from one of the host computers 20.

The storage device 13 is caching data into a cache memory as described above, and therefore returns data in the cache memory to the host computer 20 in a case of a cache hit. The cache hit operation of the storage device 13 is as in known methods, and the operation of the storage device 13 in a case of a cache miss is described.

The storage controller 60 receives a read command from one of the host computers 20 through a relevant protocol chip (S2000), and executes hit/miss determination to determine whether or not read data of the read command is found in a cache (S2010). Data needs to be read out of one of the disks in a case of a cache miss. In order to read compressed data out of a disk in which the compressed data is stored, the storage controller 60 secures a primary buffer large enough for the size of the compressed data on one of the DRAMs 70 (S2020). The storage controller 60 then activates the relevant protocol chip at the back end (S2030), thereby reading the compressed data out of the disk (S2040).

The storage controller 60 next confirms the completion of the transfer by the protocol chip (S2050), and secures a storage area (S2060) in order to cache the data into one of the cache devices 1. The data read out of the disk has been compressed and, to avoid re-compressing the already compressed data, the storage controller 60 issues an NVMe write command for non-compression writing (S2070). Specifically, the storage controller 60 gives this instruction by using the data set mgmt field 1907 of the command parameter.

The cache device 1 reads the data out of the primary buffer, stores the data non-compressed in one of the flash memories, and returns completion to the storage controller 60, by following the flow of FIG. 9.

The storage controller 60 executes completion confirmation processing in which the completion is harvested and a reception notification is returned (S2080). The storage controller 60 next calculates a size necessary for decompression, and instructs the cache device 1 to execute address mapping for decompressed state extraction (S2090). The storage controller 60 also secures, on the DRAM 70, a primary buffer to be used by the host-side protocol chip (S2100).

The storage controller 60 issues an NVMe read command with the primary buffer as the storage destination, and reads the data at the decompression state extraction address onto the primary buffer (S2110). After executing completion confirmation processing (S2120) by way of completion harvest notification, the storage controller 60 activates the relevant protocol chip to return the data in the primary buffer to the host computer 20 (S2130, S2140). Lastly, the completion of protocol chip DMA transfer is harvested (S2150), and the transfer processing is ended.

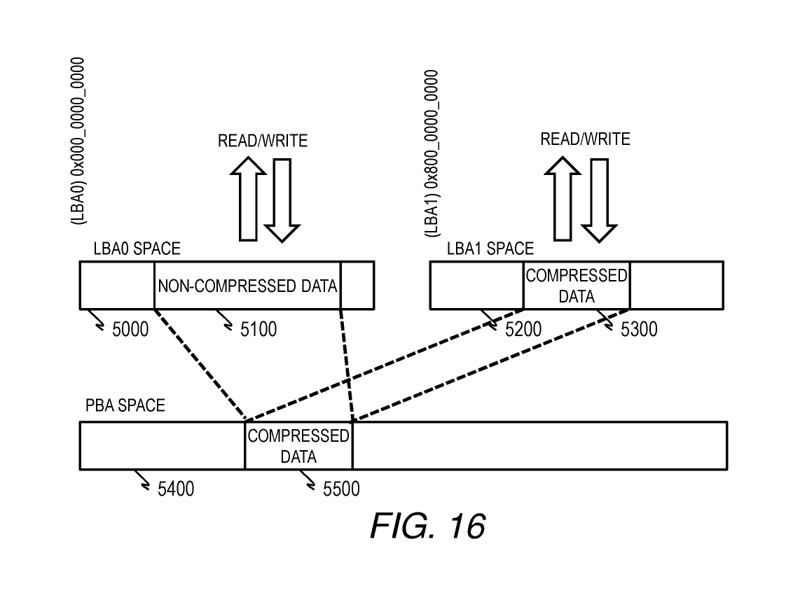

FIG. 16 is a diagram for illustrating an association relation between logical addresses (logical block addresses: LBAs) and physical addresses (physical block addresses: PBAs) in the cache device 1 when the additional address mapping is executed in Step S1310 of the host write processing illustrated in FIG. 14, and in Step S2090 of the host read processing illustrated in FIG. 15.

An LBA0 space 5000 and an LBA1 space 5200 are address spaces used by the storage controller 60 to access the cache device 1. The LBA0 space 5000 is used when non-compressed data written by the storage controller 60 is to be stored compressed, or when compressed data is decompressed to be read as non-compressed data. The LBA1 space 5200, on the other hand, is used when compressed data is to be obtained as it is, or when already compressed data is to be stored without being compressed further.

A PBA space 5400 is an address space that is used by the cache device 1 to access the FMs inside the cache device 1.

Addresses in the LBA0 space 5000 and the LBA1 space 5200 and addresses in the PBA space 5400 are associated with each other by the logical-physical conversion table described above with reference to FIG. 7.

In the host write processing of FIG. 14, data is stored compressed in Step S1050 by using an address 5100 in the LBA0 space 5000. In this case, the address corresponds to the address 5500 in the PBA space 5400. When the data is subsequently written to a disk, the destaging range is determined based on compression information that is returned in the “completion” of NVMe write. Based on the size of the destaging range, the size of the write out range is checked (S1300), to thereby allocate a compressed state extraction address 5300, which corresponds to the address 5500 in the PBA space 5400, in the LBA1 space.

It is understood from this that, in order to accomplish the double mapping of FIG. 13, the cache device 1 needs to have a mechanism of informing the host apparatus (storage controller) of the post-compression size, not just the logical-physical table 750.

In conclusion, each cache device of this embodiment has a mechanism of informing the host apparatus of the post-compression size, and the host apparatus can therefore additionally allocate a new address area from which data is extracted while kept compressed. When the address area is allocated, the host apparatus and the cache device refer to the same single piece of data, thereby eliminating the need to duplicate data and making the processing quick. In addition, with the cache device executing compression processing, the load on the storage controller is reduced and the performance of the storage device is raised. A PCIe-SSD suitable for cache use by a host apparatus is thus realized.

This embodiment also helps to increase the capacity and performance of a cache and to sophisticate functions of a cache, thereby enabling a storage device to provide new functions including the data compression function described in this embodiment.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit. The above-described configurations and functions may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings shows control lines and information lines as considered necessary for explanation but do not show all control lines or information lines in the products. It can be considered that almost of all components are actually interconnected.

1. A data memory device, comprising:
a storage medium configured to store data;
a command buffer configured to store a command that is generated by an external apparatus to give a data transfer instruction;
a command transfer direct memory access (DMA) engine, which is coupled to the external apparatus and which is a hardware circuit;
a transfer list generating DMA engine, which is coupled to the external apparatus and which is a hardware circuit; and
a data transfer DMA engine, which is coupled to the external apparatus and which is a hardware circuit,
wherein the command transfer DMA engine is configured to:
obtain the command from a memory of the external apparatus;
obtain specifics of the instruction of the command;
store the command in the command buffer;
obtain a command number that identifies the command being processed; and
activate the transfer list generating DMA engine by transmitting the command number depending on the specifics of the instruction of the command,
wherein the transfer list generating DMA engine is configured to:
identify, based on the command stored in the command buffer, an address in the memory to be transferred between the external apparatus and the data memory device; and
activate the data transfer DMA engine by transmitting the address to the data transfer DMA engine, and
wherein the data transfer DMA engine is configured to transfer data to/from the memory based on the received address.

2. The data memory device according to claim 1,
wherein the transfer list generating DMA engine is configured to transmit the command number along with the address to the data transfer DMA engine,
wherein the data transfer DMA engine is configured to activate the command transfer DMA engine by transmitting the command number to the command transfer DMA engine in a case where a transfer of the data succeeds, and
wherein the command transfer DMA engine is configured to:
generate a command response that indicates normal completion; and
transmit the command response indicating normal completion to the external apparatus.

3. The data memory device according to claim 2, further comprising a processor,
wherein the command transfer DMA engine is configured to notify, after sending the command response to the external apparatus, the processor that the command has been received from the external apparatus.

4. The data memory device according to claim 3,
wherein the command transfer DMA engine, the transfer list generating DMA engine, and the data transfer DMA engine are each configured to:
generate information that enables specifics of an error to be identified in a case where the error is detected during processing; and
activate a response DMA engine, which is included in the command transfer DMA engine, by transmitting the information, and
wherein the response DMA engine is configured to:
generate an error response command by using the information; and
transmit the error response command to the external apparatus.

5. The data memory device according to claim 4, wherein the command transfer DMA engine is configured to instruct that an area of the command buffer where the command is stored be released, in a case where a notification of confirmation of reception of the command response is received from the external apparatus.

6. The data memory device according to claim 5,
wherein the external apparatus is configured to store, in the command, compression instruction information, which indicates whether or not the data to be transferred is to be compressed, or whether or not the data to be transferred is to be decompressed,
wherein the transfer list generating DMA engine is configured to:
obtain the compression instruction information from the command; and
transmit the compression instruction information to the data transfer DMA engine, and
wherein the data transfer DMA engine is configured to determine, based on the compression instruction information, whether or not the data is to be compressed, or whether or not the data is to be decompressed.

7. The data memory device according to claim 6, wherein the data transfer DMA engine is configured to:
compress the data and transfer the compressed data to a volatile memory; and
generate, when compressing the data, compression management information, which is used by the processor to transfer the compressed data from a data buffer to the storage medium, and store the compression management information in a given area.

8. The data memory device according to claim 7,
wherein the data transfer DMA engine includes a compression/non-compression transfer circuit,
wherein the compression/non-compression transfer circuit includes an input buffer in which the data received is stored and an output buffer in which data is stored after being compressed, and
wherein the compression/non-compression transfer circuit is configured to transfer, non-compressed, the data stored in the input buffer to the volatile memory in a case where it is determined that compression processing makes the data stored in the input buffer larger than a data size at which the data is stored in the input buffer.

9. The data memory device according to claim 8,
wherein the compression/non-compression transfer circuit is configured to execute data compression for each given size of data, and
wherein the data stored in the input buffer is transferred non-compressed to the data buffer in a case where the size of the data is less than the given size.

10. The data memory device according to claim 9, further comprising a read modify write (RMW) DMA engine,
wherein the RMW DMA engine includes a first circuit configured to transfer data decompressed, a second circuit configured to transfer data read out of the data buffer as it is, a multiplexer configured to allow data that is transferred from one of the first circuit and the second circuit to pass therethrough, and a third circuit configured to compress data that has passed through the multiplexer, and
wherein the RMW DMA engine is configured to use the first circuit to:
decompress old data;
make a switch so that the multiplexer is coupled to the first circuit to allow the old data to pass therethrough for a range where the old data is not updated with the data;
make a switch so that the multiplexer is coupled to the second circuit to allow the new data to pass therethrough for a range where the old data is updated with the new data; and
use the third circuit to compress data that has passed through the multiplexer.

11. The data memory device according to claim 7, wherein the processor is configured to invalidate the compression management information of compressed old data, in a case where the compressed old data and compressed new data with which the compressed old data is updated are stored in the data buffer.

12. A storage apparatus, comprising:
a storage controller coupled to a computer;
a memory coupled to the storage controller; and
a data memory device:
wherein the data memory device includes:
a command transfer direct memory access (DMA) engine, which is coupled to the storage controller and which is a hardware circuit;
a transfer list generating DMA engine, which is coupled to the storage controller and which is a hardware circuit; and
a data transfer DMA engine, which is coupled to the storage controller and which is a hardware circuit;
wherein the storage controller is configured to:
store data requested by a write request in the memory in a case where the write request is received from the computer; and
generate a write command for storing the data in the data memory device,
wherein the command transfer DMA engine is configured to:
obtain the write command from the memory;
obtain a command number that identifies the write command being processed; and
activate the transfer list generating DMA engine by transmitting the command number to the transfer list generating DMA engine,
wherein the transfer list generating DMA engine is configured to:
identify, based on the write command, an address in the memory where the data is stored; and
activate the data transfer DMA engine by transmitting the address and the command number to the data transfer DMA engine,
wherein the data transfer DMA engine is configured to:
obtain the data based on the received address; and
activate the command transfer DMA engine by transmitting the command number to the command transfer DMA engine, and
wherein the command transfer DMA engine is configured to transmit a data transfer completion response to the storage controller.

13. The storage apparatus according to claim 12, further comprising a plurality of hard disk drives,
wherein the storage controller is configured to generate a first write command to which information instructing that the data be written compressed is attached,
wherein the data transfer DMA engine is configured to:
obtain the data from the memory; and
compress the data as instructed by the first write command, thus creating compressed data,
wherein the storage controller is configured to generate a first read command to which information instructing that the compressed data be read without being decompressed is attached,
wherein the data transfer DMA engine is configured to transfer the compressed data to the memory as instructed by the first read command, and
wherein the storage controller is configured to:
read the compressed data out of the memory; and
store the read data in at least one of the plurality of hard disk drives.

14. The storage apparatus according to claim 13,
wherein the storage controller is configured to:
read the compressed data that is requested by a read request out of one of the plurality of HDDs in a case where the read request is received from the computer;
store the read data in the memory; and
generate a second write command, which instructs that the compressed data be written non-compressed,
wherein the data transfer DMA engine is configured to obtain the compressed data from the memory as instructed by the second write command,
wherein the storage controller is configured to generate a second read command, which instructs that the compressed data be decompressed and read,
wherein the data transfer DMA engine is configured to decompress the compressed data and transfer the decompressed data to the memory as instructed by the second read command, and
wherein the storage controller is configured to read the decompressed data out of the memory and transfer the read data to the computer.
